(19) United States
(12) Patent Application Publication
(10) Pub. No.: US 2024/0289709 A1
(43) Pub. Date: Aug. 29, 2024

(54) ACTION SUGGESTION APPARATUS, ACTION SUGGESTION SYSTEM, ACTION SUGGESTION METHOD, AND NON-TRANSITORY RECORDING MEDIUM

(71) Applicant: Mayuka ARAUMI, Tokyo (JP)

(72) Inventor: Mayuka ARAUMI, Tokyo (JP)

(21) Appl. No.: 18/583,891

(22) Filed: Feb. 22, 2024

(30) Foreign Application Priority Data
Feb. 27, 2023 (JP) 2023-027900

(51) Int. Cl. G06Q 10/0631

(52) U.S. Cl. CPC G06Q 10/063114; G06Q 10/063116

(57) ABSTRACT

An action suggestion apparatus includes circuitry. The circuitry receives condition information of a user from a communication terminal used by the user, and generates first suggestion information for an action of the user based on the received condition information. The circuitry transmits the generated first suggestion information to the communication terminal, and receives, from the communication terminal, result information representing a result of the action of the user based on the first suggestion information. The circuitry generates second suggestion information for the action of the user based on the received result information.

### CROSS-REFERENCE TO RELATED APPLICATION

This patent application is based on and claims priority pursuant to 35 U.S.C. § 119 (a) to Japanese Patent Application No. 2023-027900, filed on Feb. 27, 2023, in the Japan Patent Office, the entire disclosure of which is hereby incorporated by reference herein.

### BACKGROUND

### Technical Field

Embodiments of this disclosure relate to an action suggestion apparatus, an action suggestion system, an action suggestion method, and a non-transitory recording medium.

### Related Art

There is a technique of measuring the degree of fatigue with a sensing device and a technique of suggesting a way to fatigue recovery or mental refreshment based on the measured information.

One of such techniques is measuring the activities of the autonomic nervous system to determine the pattern of the biological clock and the quality of sleep and suggesting a sleep condition or action highly correlated with fatigue recovery.

There is also a technique of determining whether a user should have mental refreshment based on the task and biological data of the user and the data of operations performed on a terminal by the user, for example, and suggesting an action highly expected to bring mental refreshment to the user.

### SUMMARY

In one embodiment of this invention, there is provided an action suggestion apparatus that includes, for example, circuitry that receives condition information of a user from a communication terminal used by the user, and generates first suggestion information for an action of the user based on the received condition information. The circuitry transmits the generated first suggestion information to the communication terminal, and receives, from the communication terminal, result information representing a result of the action of the user based on the first suggestion information. The circuitry generates second suggestion information for the action of the user based on the received result information.

In one embodiment of this invention, there is provided an action suggestion system that includes, for example, the above-described action suggestion apparatus and the communication terminal used by the user. The communication terminal includes another circuitry that causes a display to display the second suggestion information generated for the user.

In one embodiment of this invention, there is provided an action suggestion method that includes, for example, receiving condition information of a user from a communication terminal used by the user, generating first suggestion information for an action of the user based on the received condition information, transmitting the generated first suggestion information to the communication terminal, receiving, from the communication terminal, result information representing a result of the action of the user based on the first suggestion information, and generating second suggestion information for the action of the user based on the received result information.

In one embodiment of this invention, there is provided a non-transitory recording medium storing a plurality of instructions which, when executed by one or more processors, causes the one or more processors to perform the above-described action suggestion method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an exemplary general arrangement of an action suggestion system according to a first embodiment of the present invention;

FIGS. 2A and 2B are diagrams illustrating a concept of machine learning between an input layer and an output layer, FIG. 2A illustrating a concept of machine learning of schedule information and condition information of a user, and FIG. 2B illustrating a concept of machine learning of schedule information and result information of a user;

FIG. 3 is a diagram illustrating an exemplary hardware configuration of an action suggestion apparatus included in the action suggestion system of the first embodiment;

FIG. 4 is a diagram illustrating an exemplary hardware configuration of a communication terminal included in the action suggestion system of the first embodiment;

FIG. 5 is a diagram illustrating an exemplary functional configuration of the action suggestion system of the first embodiment;

FIG. 6 is a conceptual diagram illustrating an example of an attribute information management table of the first embodiment;

FIG. 7 is a conceptual diagram illustrating an example of a condition information management table of the first embodiment;

FIG. 8 is a conceptual diagram illustrating an example of an individual condition management table of the first embodiment;

FIG. 9 is a conceptual diagram illustrating an example of a suggestion information management table of the first embodiment;

FIG. 10 is a conceptual diagram illustrating an example of a suggestion history management table of the first embodiment;

FIG. 11 is a conceptual diagram illustrating an example of a result and achievement management table of the first embodiment;

FIG. 12 is a sequence diagram illustrating an example of an attribute information registration or update process of the first embodiment;

FIG. 13 is a sequence diagram illustrating an example of a result information registration and weighting process of the first embodiment;

FIG. 14 is a diagram illustrating an example of a display screen of the first embodiment for a user to input condition information;

FIG. 15 is a diagram illustrating an example of a display screen of the first embodiment displaying an action suggestion to the user;

FIG. 16 is a diagram illustrating an example of a display screen of the first embodiment for the user to input an action result;

FIG. 17 is a flowchart illustrating an example of the result information registration and weighting process of the first embodiment;

FIG. 18 is a diagram illustrating an exemplary general arrangement of an action suggestion system according to a second embodiment of the present invention;

FIG. 19 is a diagram illustrating an exemplary hardware configuration of a sensing device included in the action suggestion system of the second embodiment;

FIG. 20 is a diagram illustrating an exemplary functional configuration of the action suggestion system of the second embodiment;

FIG. 21 is a conceptual diagram illustrating an example of a biological information management table of the second embodiment;

FIG. 22 is a sequence diagram illustrating an example of a result information registration and weighting process of the second embodiment;

FIG. 23 is a diagram illustrating an exemplary general arrangement of an action suggestion system according to a third embodiment of the present invention;

FIG. 24 is a diagram illustrating an exemplary hardware configuration of a schedule management server included in the action suggestion system of the third embodiment;

FIG. 25 is a diagram illustrating an exemplary functional configuration of the action suggestion system of the third embodiment;

FIG. 26 is a conceptual diagram illustrating an example of a schedule information management table of the third embodiment;

FIG. 27 is a sequence diagram illustrating an example of a result information registration and weighting process of the third embodiment; and

FIG. 28 is a diagram illustrating an exemplary general arrangement of an action suggestion system according to a fourth embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A first embodiment of the present invention will be described.

A general arrangement of an action suggestion system of the first embodiment will first be described.

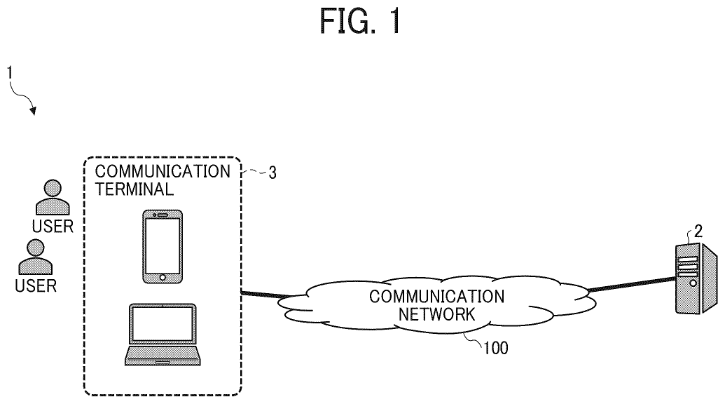

FIG. 1 is a diagram illustrating an exemplary general arrangement of an action suggestion system 1 of the first embodiment. The action suggestion system 1 illustrated in FIG. 1 (an example of an action suggestion system) includes an action suggestion apparatus 2 (an example of an action suggestion apparatus) and a communication terminal 3 (an example of a communication terminal). The action suggestion apparatus 2 presents a suggestion for the action of a user. The communication terminal 3 is used by the user. The action suggestion system 1 adjusts suggestion information for the action of the user to be appropriate to the state of the user.

The action suggestion apparatus 2 and the communication terminal 3 included in the action suggestion system 1 are connected to each other via a communication network 100. The communication network 100, over which multiple unspecified communications take place, is implemented by the Internet, an intranet, or a local area network (LAN), for example. The communication network 100 may include a wireless communication network using a standard such as 4th generation (4G), 5th generation (5G), worldwide interoperability for microwave access (WiMAX), or long term evolution (LTE). The action suggestion apparatus 2 and the communication terminal 3 may be directly connected to each other by a dedicated wired cable.

The action suggestion apparatus 2, which presents the suggestion for the action of the user, is a server, for example. That is, the action suggestion apparatus 2 is implemented by one or more information processing apparatuses (i.e., computer systems) equipped with a typical server operating system (OS), for example. The action suggestion apparatus 2 is a component forming the action suggestion system 1. A communication application for communicating with another apparatus, device, or communication terminal and an action suggestion program for suggesting an action to the user are installed and stored in storage means of the action suggestion apparatus 2.

The action suggestion apparatus 2 may be implemented by a plurality of computers to which units (i.e., functions or means) of the action suggestion apparatus 2 such as a storage unit are divided and distributed as desired. All or part of the functions of the action suggestion apparatus 2 may be implemented by a server computer that exists in a cloud or on-premise environment. Further, the action suggestion apparatus 2 may be a communication device or terminal capable of running software such as browser software.

The action suggestion apparatus 2 may communicate or transmit data or information to the communication terminal 3 through push notification (transmission). In this case, the action suggestion apparatus 2 may execute the push notification via, for example, a firebase cloud messaging (FCM) server, which is an example of a push notification server.

The communication terminal 3 used by the user may be equipped with a function of individually identifying multiple users to allow the multiple users to use the action suggestion system 1 with the same communication terminal 3. Alternatively, multiple communication terminals 3 may be connected to the action suggestion system 1 in accordance with the number of users.

The communication terminal 3 is implemented by an information processing apparatus (i.e., a communication system) for communication equipped with a typical OS, for example. The communication terminal 3 is a component forming the action suggestion system 1. A communication application for communicating with another communication terminal or another device or apparatus that provides a commonly used external service and various applications for executing various functions are installed and stored in storage means of the communication terminal 3.

The communication terminal 3 may be a communication terminal with a communication function, such as a personal computer (PC), a portable laptop PC, a mobile phone, a smartphone, a tablet terminal, or a wearable terminal in the form of eyeglasses or a watch, for example. Further, the communication terminal 3 may be a communication device, apparatus, or terminal capable of running software such as browser software and various applications (e.g., a natural language search application).

In the following embodiments, the term “action” generally refers to an action taken by the user, including an action concerning how the user uses time or how the user feels. Simply being without doing anything or focusing on one's breathing, which does not involve active movement, will also be referred to as an action.

More specifically, the action includes an action expected to improve concentration, such as eating chocolate with a high cocoa polyphenol content, doing a 3-minute jogging or strength training, or doing a 10-minute meditation practice, for example. The action also includes an action executable on the discretion of the user to address frequent common discomfort (e.g., headache, eye fatigue, or stiff shoulders), such as taking or applying pain relief medication (e.g., taking an antipyretic analgesic containing acetaminophen as a main ingredient).

Further, in the embodiments, the term “option of action” refers to an option of action medically, scientifically, or psychologically verified to have a certain degree of effect on improving the physical or mental state or enhancing concentration or creativity.

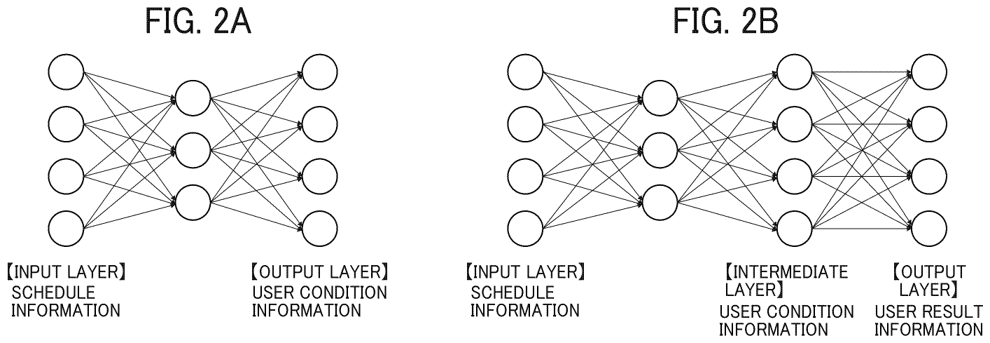

FIGS. 2A and 2B illustrate a concept of machine learning between an input layer and an output layer. FIG. 2A is a diagram illustrating a concept of machine learning of schedule information and condition information of a user. FIG. 2B is a diagram illustrating a concept of machine learning of schedule information and result information of a user.

FIG. 2A illustrates an example including the schedule information as the input layer and the user condition information as the output layer. The example further includes, as an intermediate layer, a factor that does not appear in the input (i.e., the schedule information) or the output (i.e., the user condition information) but connects the input to the output, affecting the output. Since it is desired to learn what kind of schedule causes a certain physical condition of the user, the schedule causing the physical condition is deep-learned in this example. That is, FIG. 2A illustrates a concept of machine learning used to infer the state of the user from the schedule information.

FIG. 2B illustrates an example including the schedule information as the input layer, the user result information as the output layer, and the user condition information as the intermediate layer. FIG. 2B is a diagram illustrating a case in which when the user should have taken a rest is determined from back calculation with an accumulated history of past actions of the user. The user result information as the output layer represents a result of an action taken by the user based on an action suggestion. That is, FIG. 2B illustrates a concept of machine learning used to optimize and suggest the timing of taking a rest.

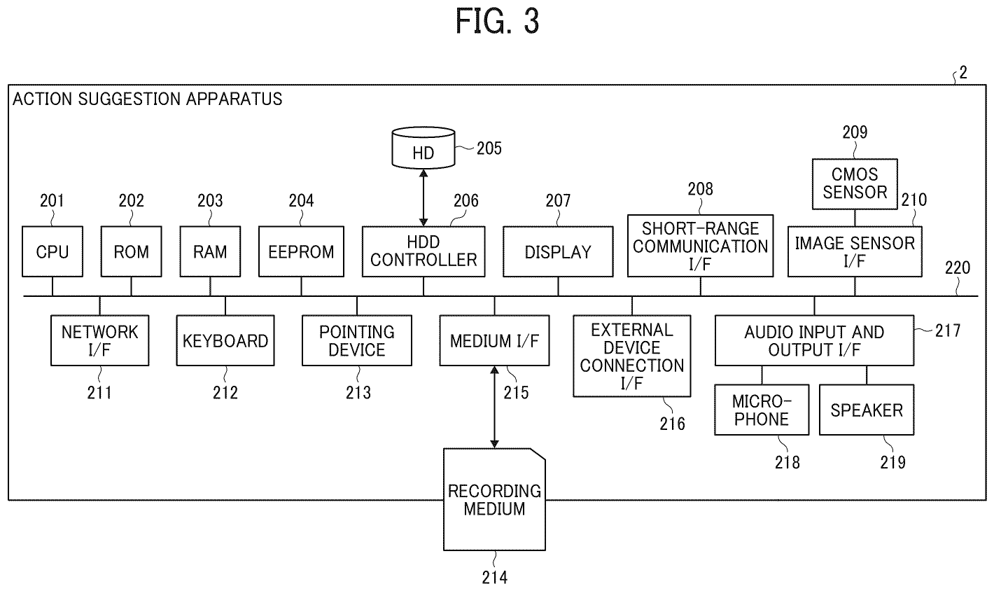

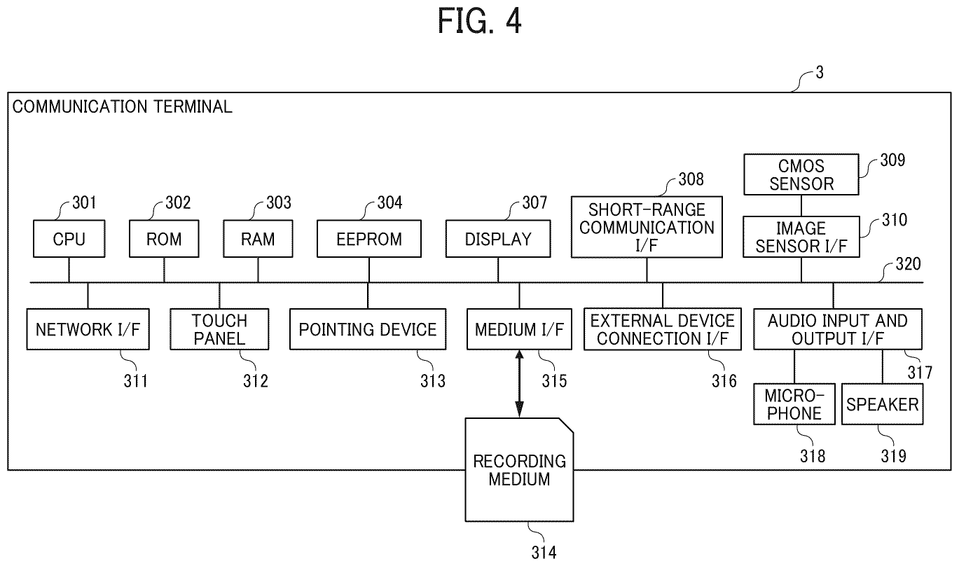

Respective hardware configurations of the action suggestion apparatus 2 and the communication terminal 3 forming the action suggestion system 1 of the first embodiment will be described with FIGS. 3 and 4. In the hardware configuration of the action suggestion apparatus 2 in FIG. 3 or the communication terminal 3 in FIG. 4, a component may be added or deleted as necessary.

FIG. 3 is a diagram illustrating an exemplary hardware configuration of the action suggestion apparatus 2 of the first embodiment. As illustrated in FIG. 3, the action suggestion apparatus 2, which is implemented by a computer, for example, includes a central processing unit (CPU) 201, a read only memory (ROM) 202, a random access memory (RAM) 203, an electrically erasable programmable read only memory (EEPROM) 204, a hard disk (HD) 205, a hard disk drive (HDD) controller 206, a display 207, a short-range communication interface (I/F) 208, a complementary metal oxide semiconductor (CMOS) sensor 209, an image sensor I/F 210, a network I/F 211, a keyboard 212, a pointing device 213, a medium I/F 215, an external device connection I/F 216, an audio input and output I/F 217, a microphone 218, a speaker 219, and a bus line 220.

The CPU 201 controls overall operation of the action suggestion apparatus 2. The ROM 202 stores a program used to drive the CPU 201, for example. The RAM 203 is used as a work area of the CPU 201. The EEPROM 204 writes or reads various data such as applications under the control of the CPU 201. The HD 205 stores various data such as programs. The HDD controller 206 controls the writing and reading of various data to and from the HD 205 under the control of the CPU 201. The hardware configuration of the action suggestion apparatus 2 may include a solid state drive (SSD) in place of the HD 205 and the HDD controller 206. The display 207 displays various information such as a cursor, menus, windows, text, and images. In the first embodiment, the display 207 functions as an example of display means. The short-range communication I/F 208 is a communication circuit with a wireless communication interface conforming to a standard such as near field communication (NFC), Bluetooth®, or wireless fidelity (Wi-Fi®) to perform data communication with a communication device or terminal. The CMOS sensor 209 is a type of built-in image capturing means that captures the image of a subject under the control of the CPU 201 to obtain image or video data. The image capturing means may be implemented by a charge coupled device (CCD) sensor, for example, in place of the CMOS sensor. The image sensor I/F 210 is a circuit that controls the driving of the CMOS sensor 209.

The network I/F 211 is an interface for performing data communication via the communication network 100. The keyboard 212 is a type of input means with a plurality of keys for inputting text, numerical values, and various instructions, for example. In addition to or in place of the keyboard 212, the action suggestion apparatus 2 may include input means such as a touch panel for operating particular buttons and icons, for example. The pointing device 213 is a type of input means for selecting and executing various instructions, selecting a processing target, and moving the cursor, for example. The medium I/F 215 controls the writing (storage) and reading of data to and from a recording medium 214 such as a flash memory. The external device connection I/F 216 is an interface for connecting various external devices to the action suggestion apparatus 2. The external device connection I/F 216 is connected to the communication terminal 3 with a dedicated wired cable. The external devices include a universal serial bus (USB) memory, for example. The audio input and output I/F 217 is a circuit that processes the input of audio signal from the microphone 218 and the output of audio signal to the speaker 219 under the control of the CPU 201. The microphone 218 is a built-in circuit that converts sound into electrical signal. The microphone 218 acquires voice or sound wave emitted from an external speaker, for example, to acquire information using electrical signal. The speaker 219 is a built-in circuit that converts electrical signal into physical vibration to produce the sound of music or voice, for example. The bus line 220 includes address buses and data buses for electrically connecting the CPU 201 and the other components to each other.

FIG. 4 is a diagram illustrating an exemplary hardware configuration of the communication terminal 3 of the first embodiment. As illustrated in FIG. 4, the communication terminal 3, which is implemented by a computer, for example, includes a CPU 301, a ROM 302, a RAM 303, an EEPROM 304, a display 307, a short-range communication I/F 308, a CMOS sensor 309, an image sensor I/F 310, a network I/F 311, a touch panel 312, a pointing device 313, a medium I/F 315, an external device connection I/F 316, an audio input and output I/F 317, a microphone 318, a speaker 319, and a bus line 320.

The CPU 301 controls overall operation of the communication terminal 3. The ROM 302 stores a program used to drive the CPU 301, for example. The RAM 303 is used as a work area of the CPU 301. The EEPROM 304 writes or reads various data such as applications under the control of the CPU 301. The EEPROM 304 stores various setting data or information, for example. The hardware configuration of the communication terminal 3 may include an SSD in place of the EEPROM 304. The display 307 displays various information such as a cursor, menus, windows, text, and images. In the first embodiment, the display 307 functions as an example of display means. The short-range communication I/F 308 is a communication circuit with a wireless communication interface conforming to a standard such as NFC, Bluetooth®, or Wi-Fi® to perform data communication with a communication device or terminal. The CMOS sensor 309 is a type of built-in image capturing means that captures the image of a subject under the control of the CPU 301 to obtain image or video data. The image capturing means may be implemented by a CCD sensor, for example, in place of the CMOS sensor. The image sensor I/F 310 is a circuit that controls the driving of the CMOS sensor 309.

The network I/F 311 is an interface for performing data communication via the communication network 100. The touch panel 312 is a type of input means with a plurality of keys for inputting text, numerical values, and various instructions, for example. In addition to or in place of the touch panel 312, the communication terminal 3 may include input means such as a keyboard for operating particular buttons and icons, for example. The pointing device 313 is a type of input means for selecting and executing various instructions, selecting a processing target, and moving the cursor, for example. The medium I/F 315 controls the writing (storage) and reading of data to and from a recording medium 314 such as a flash memory. The external device connection I/F 316 is an interface for connecting various external devices to the communication terminal 3. The external device connection I/F 316 is connected to another device or communication terminal with a dedicated wired cable. The external devices include a USB memory, for example. The audio input and output I/F 317 is a circuit that processes the input of audio signal from the microphone 318 and the output of audio signal to the speaker 319 under the control of the CPU 301. The microphone 318 is a built-in circuit that converts sound into electrical signal. The microphone 318 acquires voice or sound wave emitted from an external speaker, for example, to acquire information using electrical signal. The speaker 319 is a built-in circuit that converts electrical signal into physical vibration to produce the sound of music or voice, for example. The bus line 320 includes address buses and data buses for electrically connecting the CPU 301 and the other components to each other.

Each of the above-described programs may be recorded on a computer readable recording medium in an installable or executable file format, or may be downloaded and distributed via a network. Examples of the recording medium include a compact disc-recordable (CD-R), a digital versatile disk (DVD), a Blu-ray® disc, a secure digital (SD) card, and a USB card. The recording medium may be shipped to a domestic or international market as a program product. For example, the action suggestion system 1 implements an action suggestion method according to an embodiment of the present invention by executing a program according to an embodiment of the present invention.

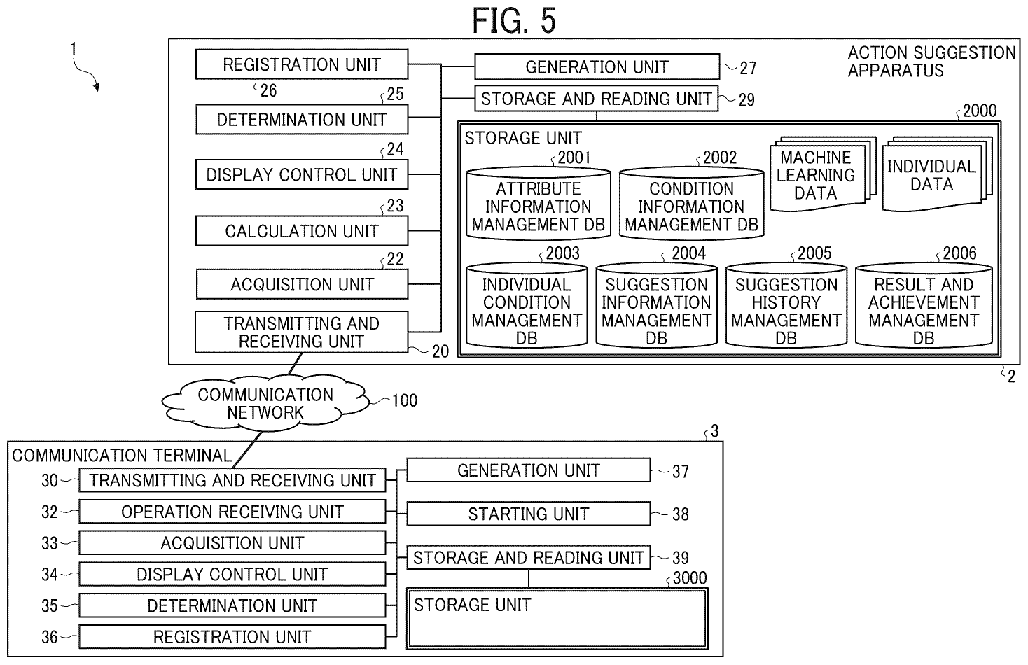

A functional configuration of the action suggestion system 1 of the first embodiment will be described with FIGS. 5 to 11.

FIG. 5 is a diagram illustrating an exemplary functional configuration of the action suggestion system 1 of the first embodiment. FIG. 5 illustrates functional units of the action suggestion apparatus 2 and the communication terminal 3 illustrated in FIG. 1, specifically functional units thereof related to later-described processes or operations.

A functional configuration of the action suggestion apparatus 2 will first be described.

As illustrated in FIG. 5, the action suggestion apparatus 2 includes a transmitting and receiving unit 20, an acquisition unit 22, a calculation unit 23, a display control unit 24, a determination unit 25, a registration unit 26, a generation unit 27, and a storage and reading unit 29. Each of these functional units is a function or means implemented through the operation of one of the hardware resources illustrated in FIG. 3 based on a command from the CPU 201 in accordance with a program for the action suggestion apparatus 2 deployed on the RAM 203 from at least one of the ROM 202, the EEPROM 204, the HD 205, or the recording medium 214. The action suggestion apparatus 2 further includes a storage unit 2000, which is implemented by at least one of the ROM 202, the EEPROM 204, the HD 205, or the recording medium 214 illustrated in FIG. 3. The storage unit 2000 stores, for example, a browser application and a communication program (i.e., communication application) for communicating with the communication terminal 3 via the communication network 100.

The functional units of the action suggestion apparatus 2 will be described in detail.

The transmitting and receiving unit 20 of the action suggestion apparatus 2 illustrated in FIG. 5 is mainly implemented by the processing of the CPU 201 on the network I/F 211 and the short-range communication I/F 208. The transmitting and receiving unit 20 transmits and receives various data or information to and from the communication terminal 3 via the communication network 100. The transmitting and receiving unit 20 further receives condition information of the user transmitted from the communication terminal 3 used by the user. Further, the transmitting and receiving unit 20 transmits generated first suggestion information to the communication terminal 3 of the user. The transmitting and receiving unit 20 transmits the first suggestion information to the communication terminal 3 with particular timing according to the condition information and result information of the user. The transmitting and receiving unit 20 further receives, from the communication terminal 3, the result information representing the result of the action of the user based on the first suggestion information. In the first embodiment, the transmitting and receiving unit 20 functions as an example of at least one of transmitting means or receiving means.

The acquisition unit 22 is mainly implemented by the processing of the CPU 201. The acquisition unit 22 acquires action information matching particular conditions from a later-described condition information management database (DB). In the first embodiment, the acquisition unit 22 functions as an example of acquisition means.

The calculation unit 23 is mainly implemented by the processing of the CPU 201. The calculation unit 23 registers the result information corresponding to the action suggestion, and weights the action suggestion. In the first embodiment, the calculation unit 23 functions as an example of calculation means.

The display control unit 24 is mainly implemented by the processing of the CPU 201 on the display 207 of the action suggestion apparatus 2 or the display 307 of the communication terminal 3. The display control unit 24 controls the display of various screens and information or data in the action suggestion apparatus 2 or the communication terminal 3. The display control unit 24 further causes the display 207 to display a display screen generated in hypertext markup language (HTML) with a browser, for example. In the first embodiment, the display control unit 24 functions as an example of display control means.

The determination unit 25 is mainly implemented by the processing of the CPU 201. In the action suggestion apparatus 2, the determination unit 25 makes various determinations. In the first embodiment, the determination unit 25 functions as an example of determination means.

The registration unit 26 is mainly implemented by the processing of the CPU 201. Based on attribute information (e.g., a user identifier (ID) and a password) transmitted by the communication terminal 3, the registration unit 26 registers attribute information of the user of the communication terminal 3. In the first embodiment, the registration unit 26 functions as an example of registration means.

The generation unit 27 is mainly implemented by the processing of the CPU 201. The generation unit 27 generates various information to be transmitted to the communication terminal 3. The generation unit 27 further generates the first suggestion information for the action based on the condition information received from the communication terminal 3. The generation unit 27 also generates second suggestion information for the action of the user in accordance with the result information received from the communication terminal 3. The generation unit 27 generates the first suggestion information based on the condition information, which includes at least one of the attribute information representing attributes of the user, physical and mental information related to the body and mind of the user, environmental information of an environment surrounding the user, or schedule information representing a schedule of the user. The generation unit 27 further generates the second suggestion information by updating a particular machine learning model in accordance with the result information.

In accordance with the result information corresponding to the first suggestion information generated for the individual user, the generation unit 27 weights the first suggestion information and generates the second suggestion information for the user in accordance with the weighting. If the result information represents a positive result, the generation unit 27 weights the first suggestion information to increase the priority of the first suggestion information being generated again, and generates the second suggestion information in accordance with the weighting. If the result information represents a negative result, the generation unit 27 weights the first suggestion information to lower the priority of the first suggestion information being generated again, and generates the second suggestion information in accordance with the weighting. Even when the first suggestion information is weighted to increase the priority of the first suggestion information being generated again, the generation unit 27 sets a limit in generating the second suggestion information based on this weighting, to thereby generate the second suggestion information in accordance with the physical and mental information of the user. The generation unit 27 further weights the first suggestion information based on information including other result information of another user whose attribute information is similar to the attribute information of the user. In the first embodiment, the generation unit 27 functions as an example of generation means.

The storage and reading unit 29 is mainly implemented by the processing of the CPU 201 on at least one of the ROM 202, the EEPROM 204, the HD 205, or the recording medium 214. The storage and reading unit 29 stores various data or information in the storage unit 2000 and reads various data or information from the storage unit 2000. In the first embodiment, the storage and reading unit 29 functions as an example of storage and reading means.

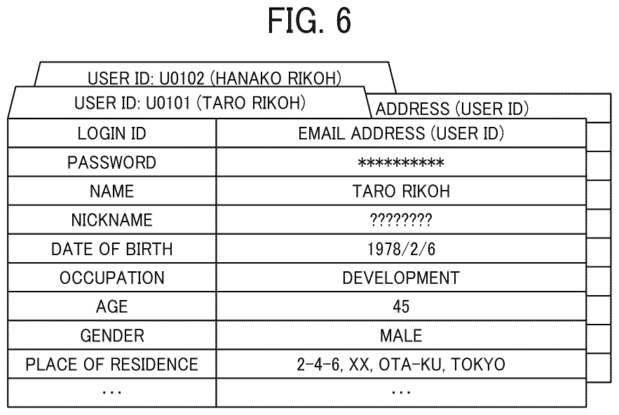

FIG. 6 is a conceptual diagram illustrating an example of an attribute information management table of the first embodiment. A data table described below is illustrative and does not limit the attribute information management table. The storage unit 2000 stores an attribute information management DB 2001 (see FIG. 5), which is implemented by the attribute information management table illustrated in FIG. 6, for example. In the attribute information management table, various items of the attribute information of the user, such as login ID, password, name, nickname, date of birth, occupation, age, gender, and place of residence, are stored and managed in association with each other for each tab with a user ID. The user ID is identification information for identifying the user, such as “U0101” or “U0102,” for example. Alternatively, the user ID may be an electronic mail (email) address of the user, for example. The content of each of the items of the attribute information is retained unless updated by the corresponding user or an administrator who manages the information of the user.

In the first embodiment, the attribute information management table (the attribute information management DB 2001) functions as an example of attribute information management means.

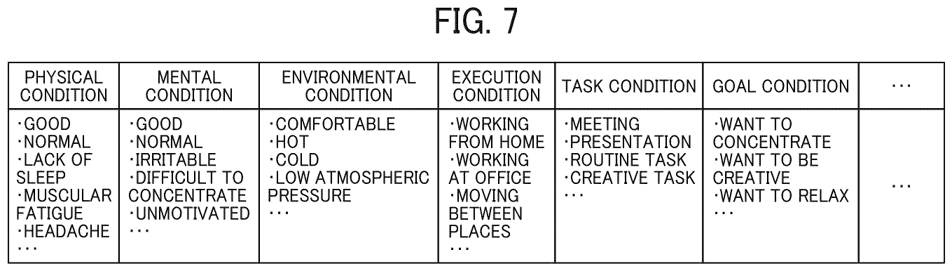

FIG. 7 is a conceptual diagram illustrating an example of a condition information management table of the first embodiment. A data table described below is illustrative and does not limit the condition information management table. The storage unit 2000 stores a condition information management DB 2002 (see FIG. 5), which is implemented by the condition information management table illustrated in FIG. 7, for example. In the condition information management table, conditions including physical condition, mental condition, environmental condition, execution condition, task condition, and goal condition are managed. In each of the conditions, specific items are managed.

For example, in the physical condition including the degree of excess or deficiency of sleep, the degree of physical or muscular fatigue, the degree of eye fatigue, and other physical conditions of the user, items such as “good,” “normal,” “lack of sleep,” “muscular fatigue,” and “headache” are managed.

In the mental condition including the mood, the irritability level, and the concentration level of the user, and like or dislike of the task on which the user is working, items of emotion as a mental state of the user, such as “good,” “normal,” “irritable,” “difficult to concentrate,” and “unmotivated,” are managed.

In the environmental condition including weather, temperature, atmospheric pressure, and noise, items such as “comfortable,” “hot,” “cold,” and “low atmospheric pressure” are managed.

In the execution condition related to whether the suggested action is executable, such as the location and the leisure time of the user, items such as “working from home,” “working at office,” and “moving between places” are managed.

In the task condition indicating a previous or subsequent task of the user, for example, items such as “meeting,” “presentation,” “routine task,” and “creative task” are managed.

In the goal condition indicating the state which the user aims to achieve in the subsequent task, such as creativity being enhanced, concentration being improved, or anxiety being relieved, items such as “want to concentrate,” “want to be creative,” and “want to relax” are managed.

In the first embodiment, the condition information management table (the condition information management DB 2002) functions as an example of condition information management means.

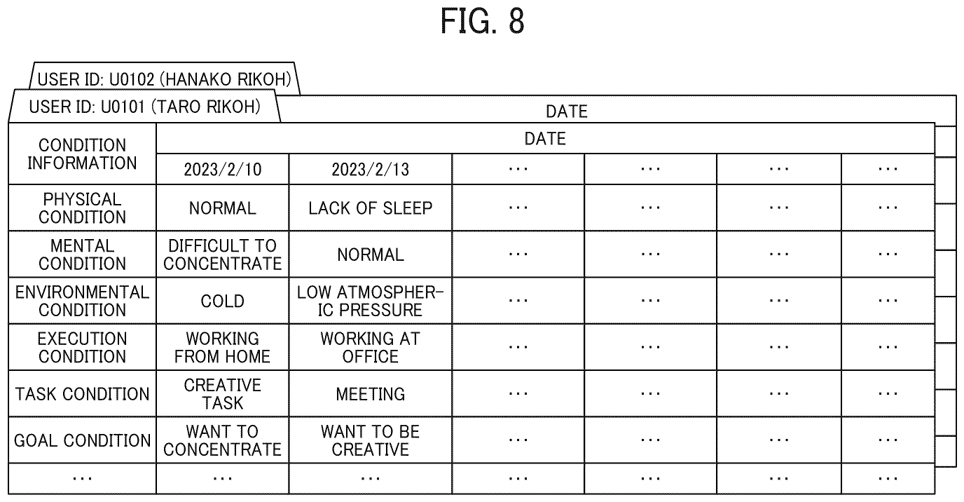

FIG. 8 is a conceptual diagram illustrating an example of an individual condition management table of the first embodiment. A data table described below is illustrative and does not limit the individual condition management table. The storage unit 2000 stores an individual condition management DB 2003 (see FIG. 5), which is implemented by the individual condition management table illustrated in FIG. 8, for example. In the individual condition management table, the condition information and the date are stored and managed in association with each other for each tab with a user ID. The condition information corresponds to the items managed in the condition information management DB 2002. In the individual condition management table, the content of the items of the condition information registered on particular dates is managed, enabling centralized management of changes of a user in the respective conditions on the respective dates.

In the first embodiment, the individual condition management table (the individual condition management DB 2003) functions as an example of individual condition management means.

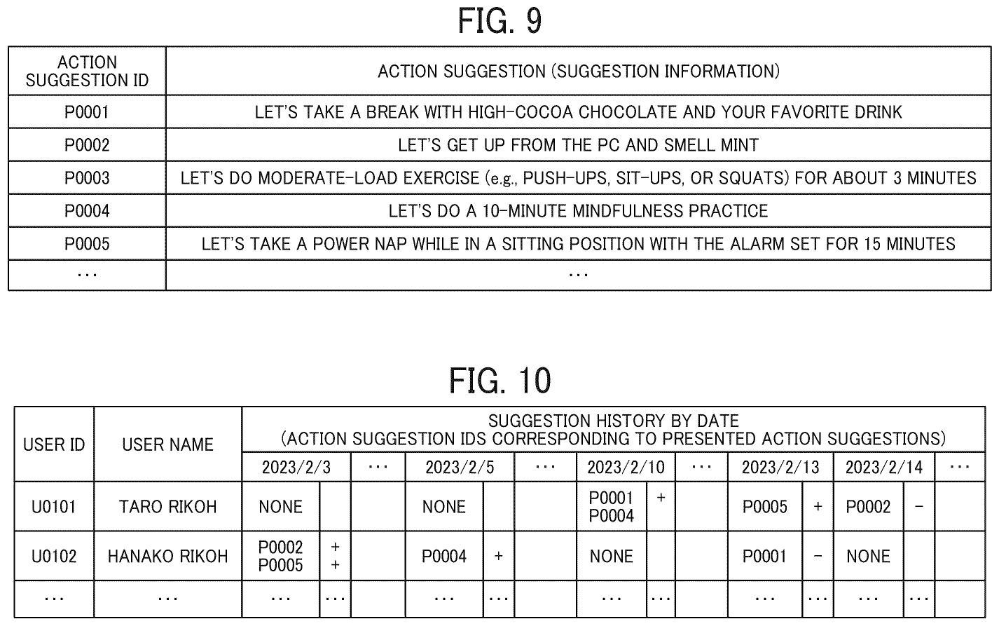

FIG. 9 is a conceptual diagram illustrating an example of a suggestion information management table of the first embodiment. A data table described below is illustrative and does not limit the suggestion information management table. The storage unit 2000 stores a suggestion information management DB 2004 (see FIG. 5), which is implemented by the suggestion information management table illustrated in FIG. 9, for example. In the suggestion information management table, the action suggestion (the first suggestion information) is managed in association with a corresponding action suggestion ID. The action suggestion ID is identification information for identifying the suggestion for the action of the user, such as “P0001” or “P0002,” for example. The action suggestion (the first suggestion information) is a message indicating a specific suggestion such as “Let's take a break with high-cocoa chocolate and your favorite drink” or “Let's get up from the PC and smell mint,” for example.

It is desirable that multiple (e.g., two to five) action suggestions are prepared as candidates for the actual suggestion to the user, and that the multiple action suggestions suggest different types of action. Specifically, it is desirable to present diverse options such as physical activity, watching or listening to something, and eating or drinking.

The suggestions of the suggestion information management table managed in association with the items of the condition information managed in the individual condition management table are adjusted to avoid presenting an inappropriate suggestion, such as suggesting jogging when the physical condition of the user is not good or when bad weather is input as the environmental condition, or suggesting a meditation practice when the user needs to move between places in a short time. As a specific example of this adjustment, if information that the user may be pregnant is input as the physical condition, an action of drinking coffee will not be suggested to the user, even though coffee is expected to enhance information processing ability and reduce mental stress. Further, even if the user is in a good physical condition and prefers to take the action, the maximum number of suggestions for the action is limited to about two to three a day to avoid the risk of excessive caffeine intake.

In the first embodiment, the suggestion information management table (the suggestion information management DB 2004) functions as an example of suggestion information management means.

FIG. 10 is a conceptual diagram illustrating an example of a suggestion history management table of the first embodiment. A data table described below is illustrative and does not limit the suggestion history management table. The storage unit 2000 stores a suggestion history management DB 2005 (see FIG. 5), which is implemented by the suggestion history management table illustrated in FIG. 10, for example. In the suggestion history management table, user name and suggestion history by date (i.e., the action suggestion IDs corresponding to the presented action suggestions) are managed in association with each other for each user ID. In the suggestion history by date, the action suggestion IDs managed in the suggestion information management table are managed as the suggestions by date. For example, when a user named Taro Rikoh is assigned with a user ID “U0101,” action suggestion IDs “P0001” and “P0004” of action suggestions presented on Feb. 10, 2003 (hereinafter referred to as 2023 Feb. 10) are managed in the suggestion history management table, and a field for adding the plus or minus sign is provided next to each of the action suggestion IDs. The plus or minus sign is a weight flag for weighting each action suggestion in accordance with whether the action suggestion is positive (effective) based on the result information from the user in response to the action suggestion presented by the action suggestion apparatus 2 based on machine learning. A process of assigning the weight flag will be described later.

In the first embodiment, the suggestion history management table (the suggestion history management DB 2005) functions as an example of suggestion history management means.

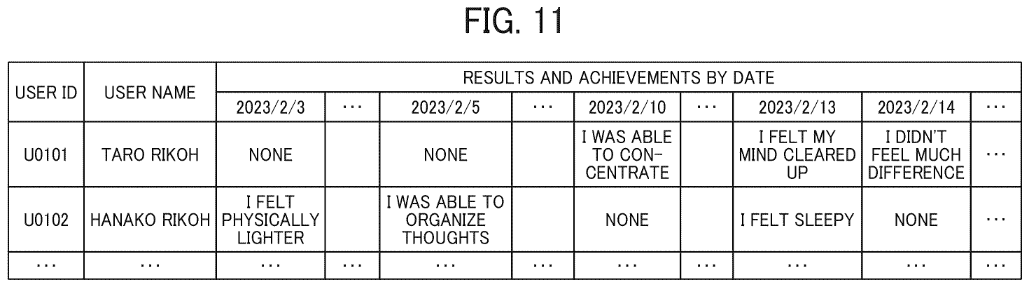

FIG. 11 is a conceptual diagram illustrating an example of a result and achievement management table of the first embodiment. A data table described below is illustrative and does not limit the result and achievement management table. The storage unit 2000 stores a result and achievement management DB 2006 (see FIG. 5), which is implemented by the result and achievement management table illustrated in FIG. 11, for example. In the result and achievement management table, user name and results and achievements by date are managed in association with each other for each user ID. The results and achievements by date represent the results input by the user who has acted based on the suggestions of the suggestion history by date (i.e., the action suggestion IDs corresponding to the presented action suggestions), which are managed in the above-described suggestion history management table. A screen for the user to input the action result (i.e., the result information) will be described later.

In the first embodiment, the result and achievement management table (the result and achievement management DB 2006) functions as an example of result and achievement management means.

A functional configuration of the communication terminal 3 will be described.

As illustrated in FIG. 5, the communication terminal 3 includes a transmitting and receiving unit 30, an operation receiving unit 32, an acquisition unit 33, a display control unit 34, a determination unit 35, a registration unit 36, a generation unit 37, a starting unit 38, and a storage and reading unit 39. Each of these functional units is a function or means implemented through the operation of one of the hardware resources illustrated in FIG. 4 based on a command from the CPU 301 in accordance with a program for the communication terminal 3 deployed on the RAM 303 from at least one of the ROM 302, the EEPROM 304, or the recording medium 314. The communication terminal 3 further includes a storage unit 3000, which is implemented by at least one of the ROM 302, the EEPROM 304, or the recording medium 314 illustrated in FIG. 4. The storage unit 3000 stores, for example, a browser application and a communication program (i.e., communication application) for communicating with the action suggestion apparatus 2 via the communication network 100.

The functional units of the communication terminal 3 will be described in detail.

The transmitting and receiving unit 30 of the communication terminal 3 illustrated in FIG. 5 is mainly implemented by the processing of the CPU 301 on the network I/F 311 and the short-range communication I/F 308. The transmitting and receiving unit 30 transmits and receives various data or information to and from the action suggestion apparatus 2 via the communication network 100. In the first embodiment, the transmitting and receiving unit 30 functions as an example of at least one of transmitting means or receiving means.

The operation receiving unit 32 is mainly implemented by the CPU 301 processing signals generated through various operations received by at least one of the display 307, the touch panel 312, or the pointing device 313. The signals for implementing the operation receiving unit 32 may be generated through various operations received by input means such as a keyboard in place of the display 307, the touch panel 312, or the pointing device 313. In the first embodiment, the operation receiving unit 32 functions as an example of receiving means.

The acquisition unit 33 is mainly implemented by the processing of the CPU 301. The acquisition unit 33 acquires various information or data from the action suggestion apparatus 2, which is received by the transmitting and receiving unit 30. In the first embodiment, the acquisition unit 33 functions as an example of acquisition means.

The display control unit 34 is mainly implemented by the processing of the CPU 301 on the display 307 of the communication terminal 3. The display control unit 34 controls the display of various screens and information or data in the communication terminal 3. The display control unit 34 further causes the display 307 to display the second suggestion information generated for the user. In the first embodiment, the display control unit 34 functions as an example of display control means.

The determination unit 35 is mainly implemented by the processing of the CPU 301. In the communication terminal 3, the determination unit 35 makes various determinations. In the first embodiment, the determination unit 35 functions as an example of determination means.

The registration unit 36 is mainly implemented by the processing of the CPU 301. The registration unit 36 registers the attribute information (e.g., the user ID and the password) transmitted by the communication terminal 3 as the attribute information to be reused in the communication terminal 3. In the first embodiment, the registration unit 36 functions as an example of registration means.

The generation unit 37 is mainly implemented by the processing of the CPU 301. The generation unit 37 generates, for example, various screen information to be displayed on the display 307 of the communication terminal 3. In the first embodiment, the generation unit 37 functions as an example of generation means.

The starting unit 38 is mainly implemented by the processing of the CPU 301. The starting unit 38 starts, for example, various functional applications and browsers installed in the communication terminal 3. In the first embodiment, the stating unit 38 functions as an example of starting means.

The storage and reading unit 39 is mainly implemented by the processing of the CPU 301 on at least one of the ROM 302, the EEPROM 304, or the recording medium 314. The storage and reading unit 39 stores various data or information in the storage unit 3000 and reads various data or information from the storage unit 3000. In the first embodiment, the storage and reading unit 39 functions as an example of storage and reading means.

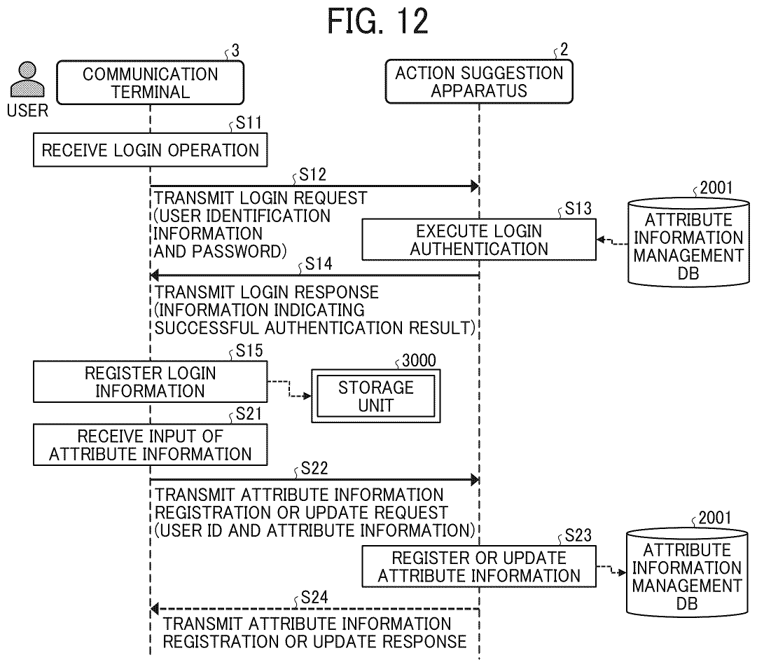

Processes or operations performed in the action suggestion system 1 of the first embodiment will be described with FIGS. 12 to 17.

A process of generating and registering various setting information will first be described.

FIG. 12 is a sequence diagram illustrating an example of an attribute information registration or update process of the first embodiment. As illustrated in FIG. 12, with the communication terminal 3, the user of the action suggestion system 1 starts an application for communicating with the action suggestion apparatus 2, or accesses a particular uniform resource locator (URL) to start a world wide web (Web) browser. Thereby, the operation receiving unit 32 of the communication terminal 3 receives the start of the functional application or the Web browser and then a login operation performed by the user (step S11). Specifically, the operation receiving unit 32 of the communication terminal 3 receives an operation of starting a particular application or Web browser displayed on the display 307 of the communication terminal 3. The operation receiving unit 32 then receives the login operation performed by the user. The login operation received by the operation receiving unit 32 may be a login operation (i.e., the input of the user ID and the password) performed by the administrator on a login screen displayed on the display 307.

The transmitting and receiving unit 30 then transmits a login request to the action suggestion apparatus 2 (step S12). Thereby, the transmitting and receiving unit 20 of the action suggestion apparatus 2 receives the login request transmitted by the communication terminal 3. The login request transmitted in this step includes the user ID (e.g., email address) and the password as user identification information.

Then, together with the determination unit 25, the storage and reading unit 29 of the action suggestion apparatus 2 searches the attribute information management DB 2001 (see FIG. 6) with the user ID (e.g., email address) received in step S12 as a search key to read the corresponding attribute information from the attribute information management DB 2001 (step S13). Specifically, the storage and reading unit 29 reads the password corresponding to the received user ID (e.g., email address), and the determination unit 25 compares the thus-read password with the password received in step S12 to determine if the two passwords match. If the authentication succeeds with the login information transmitted by the communication terminal 3, the input user ID and password are determined to be valid, and the registration unit 26 recognizes that the login process has been performed with the corresponding user name.

Then, the transmitting and receiving unit 20 of the action suggestion apparatus 2 transmits a login response to the communication terminal 3 as a response to the login request received in step S12 (step S14). Thereby, the transmitting and receiving unit 30 of the communication terminal 3 receives the login response transmitted by the action suggestion apparatus 2. The login response transmitted in this step includes authentication result information (e.g., information indicating a successful login authentication result).

Then, the registration unit 36 of the communication terminal 3 registers the login information (step S15). Specifically, the registration unit 36 stores and registers various information of the user, such as the user ID and the password, in a particular area of the storage unit 3000 as the login information input, transmitted, and received in steps S11 to S14. Depending on the configuration of the action suggestion system 1, the login authentication process may be executed each time the user performs the login process. Further, in place of the particular area of the storage unit 3000, a login information management DB forming a login information management table may be created in the communication terminal 3.

The above-described processes of step S11 to S15 may be limited to when the functional application or the Web browser for executing a particular function is first started. In the following communication with another apparatus, therefore, it may be assumed that processes such as the login authentication process according to the above-described procedure and a process for establishing a session have succeeded in the communication terminal 3, making the communication terminal 3 communicable with the another apparatus.

Then, the operation receiving unit 32 receives the input of the attribute information (step S21). Specifically, the operation receiving unit 32 receives the input of the attribute information of the user, which is input to the communication terminal 3 by the user.

The transmitting and receiving unit 30 then transmits an attribute information registration or update request to the action suggestion apparatus 2 (step S22). Thereby, the transmitting and receiving unit 20 of the action suggestion apparatus 2 receives the attribute information registration or update request transmitted by the communication terminal 3. The attribute information registration or update request transmitted in this step includes the user ID and the attribute information of the user.

Then, the registration unit 26 of the action suggestion apparatus 2 registers or updates the attribute information (step S23). Specifically, as the attribute information of the user included in the attribute information registration or update request received in step S22, the registration unit 26 registers the attribute information managed in the attribute information management DB 2001 (see FIG. 6) and corresponding to the user ID received in step S22.

The transmitting and receiving unit 20 then transmits an attribute information registration or update response to the communication terminal 3 as a response to the attribute information registration or update request received in step S22 (step S24). Thereby, the transmitting and receiving unit 30 of the communication terminal 3 receives the attribute information registration or update response transmitted by the action suggestion apparatus 2. The process of step S24 may be omitted.

In the action suggestion system 1 of the first embodiment, another device or apparatus may exist between the communication terminal 3 and the action suggestion apparatus 2 in the execution of the above-described processes of steps S12 and S14 or steps S22 and S24, for example. That is, the information or data transmitted and received between the communication terminal 3 and the action suggestion apparatus 2 may be relayed by another device or apparatus. The above-described configuration is also applicable to a case where there is another processing step between the communication terminal 3 and the action suggestion apparatus 2.

A description will be given of a process performed by the user to register various information in the action suggestion apparatus 2.

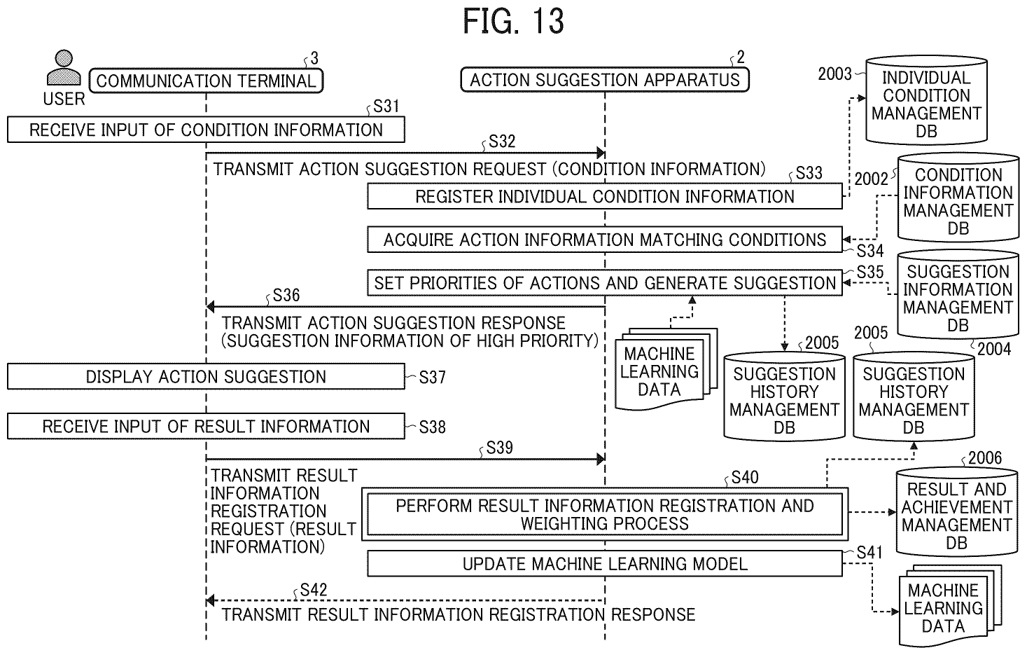

FIG. 13 is a sequence diagram illustrating an example of a result information registration and weighting process of the first embodiment. The operation receiving unit 32 first receives the input of the condition information by the user (step S31). Specifically, the operation receiving unit 32 receives the input of the condition information on a condition information input screen by the user. The condition information input screen is displayed on the display 307 by the application or browser started on the communication terminal 3.

A description will be given of an example of a display screen of the first embodiment for inputting the condition information.

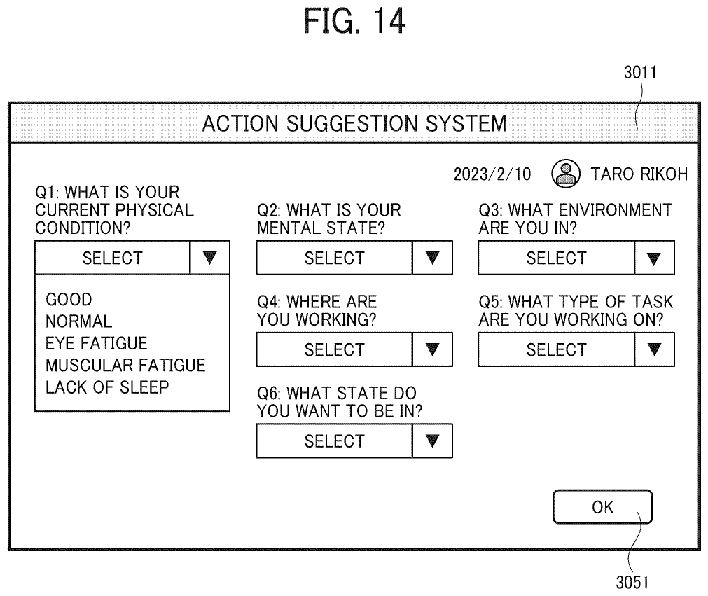

FIG. 14 is a diagram illustrating an example of the display screen of the first embodiment for inputting the condition information. In FIG. 14, the display control unit 34 of the communication terminal 3 of the user causes the display 307 of the communication terminal 3 to display a condition information input screen 3011. The condition information input screen 3011 displays the current date, the user name, and dialog screens. Each of the dialog screens includes options of the corresponding condition selectable with a pull-down menu key. The condition is the physical condition, the mental condition, the environmental condition, the execution condition, the task condition, or the goal condition, which is managed in the condition information management DB 2002 (see FIG. 7). The display control unit 34 further causes the display 307 to display an OK button 3051 in the condition information input screen 3011 to allow the user to confirm the inputs (i.e., selections). The user thus inputs (i.e., selects) the items of the condition information, such as the current physical condition and mind state of the user, in the dialog screens to register the input items of the condition information in the action suggestion apparatus 2.

Referring back to FIG. 13, the transmitting and receiving unit 30 of the communication terminal 3 transmits an action suggestion request to the action suggestion apparatus 2 (step S32). Thereby, the transmitting and receiving unit 20 of the action suggestion apparatus 2 receives the action suggestion request transmitted by the communication terminal 3. The action suggestion request transmitted in this step includes the items of the condition information input by the user in step S31.

Then, the registration unit 26 of the action suggestion apparatus 2 registers individual condition information (step S33). Specifically, the registration unit 26 registers the user ID received in step S22 of FIG. 12 and the items of the condition information received in step S32 into the corresponding items of the condition information in the individual condition management DB 2003 (see FIG. 8).

Then, the acquisition unit 22 acquires the action information matching the conditions (step S34). Specifically, the acquisition unit 22 reads the items of the condition information managed in the condition information management DB 2002 (see FIG. 7), and acquires therefrom items matching the items of the condition information input by the user on a particular date. For example, if the user Taro Rikoh inputs “good” as the physical condition on 2023 Feb. 10 in response to a question Q1 “What is your current physical condition?” in the condition information input screen 3011 illustrated in FIG. 14, the acquisition unit 22 reads and acquires “good” from the items of the physical condition in the condition information management DB 2002 via the storage and reading unit 29.

Then, the generation unit 27 sets priorities of actions and generates a suggestion (step S35). Specifically, via the storage and reading unit 29, the generation unit 27 reads the action information matching the conditions, i.e., the action information acquired in step S34, and the machine learning data managed in the storage unit 2000. The generation unit 27 then sets priorities of the actions with the read action information and machine learning data (i.e., machine learning model).

More specifically, via the storage and reading unit 29, the generation unit 27 reads the suggestion information of the action suggestion of high or highest priority from the action suggestions managed in the suggestion information management DB 2004 (see FIG. 9), and generates the read suggestion information as the action suggestion to that user. In this case, based on the condition information input by the user Taro Rikoh and the machine learning data, the generation unit 27 reads, for example, the suggestion information “Let's take a break with high-cocoa chocolate and your favorite drink,” which is managed with the action suggestion ID “P0001.” The generation unit 27 then generates this suggestion information as the action suggestion to the user Taro Rikoh as of 2023 Feb. 10. Similarly, the generation unit 27 reads suggestion information “Let's do a 10-minute mindfulness practice,” which is managed with the action suggestion ID “P0004.” The generation unit 27 then generates this suggestion information as the action suggestion to the user Taro Rikoh as of 2023 Feb. 10.

Via the storage and reading unit 29, the generation unit 27 further registers the action suggestion IDs (e.g., “P0001” and “P0004”) managed in the suggestion history management DB 2005 (see FIG. 10) and generated as action suggestions in items of the suggestion history by date associated with the corresponding user ID and date.

Then, the transmitting and receiving unit 20 transmits an action suggestion response to the communication terminal 3 as a response to the action suggestion request (step S36). Thereby, the transmitting and receiving unit 30 of the communication terminal 3 receives the action suggestion response transmitted by the action suggestion apparatus 2. The action suggestion response transmitted in this step includes the suggestion information of the action of high or highest priority out of the actions on which the priorities are set in step S35.

Then, the display control unit 34 of the communication terminal 3 displays the action suggestion (step S37).

A description will be given of an example of a display screen of the first embodiment for displaying the action suggestion.

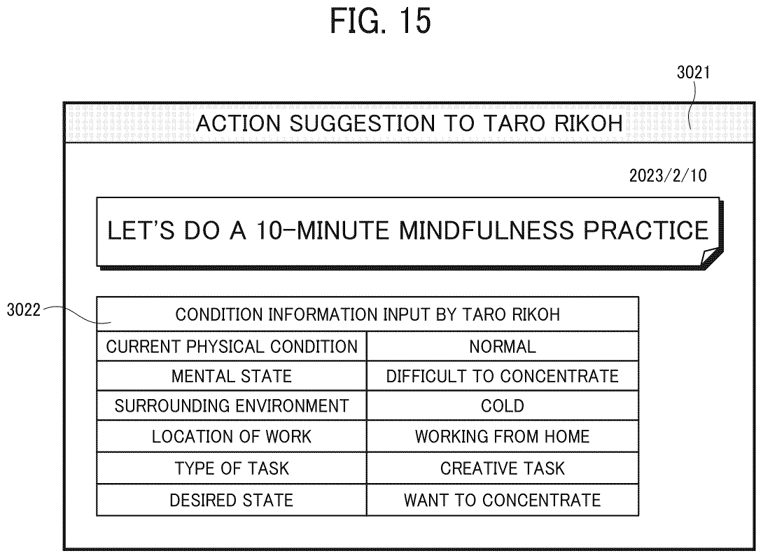

FIG. 15 is a diagram illustrating an example of the display screen of the first embodiment for displaying the action suggestion to the user. In FIG. 15, the display control unit 34 of the communication terminal 3 of the user causes the display 307 of the communication terminal 3 to display an action suggestion display screen 3021. The action suggestion display screen 3021 displays the tile of the action suggestion, the current date, the name of the user to whom the suggestion is presented, the action suggestion (e.g., a message “Let's do a 10-minute mindfulness practice”), and the condition information input by the user to whom the suggestion is presented. In this case, the condition information may be displayed in a table format, for example. The action suggestion to be presented is not necessarily a single suggestion; a plurality of action suggestions may be displayed. In the present example, the condition information input by the user Taro Rikoh includes “normal,” “difficult to concentrate,” “cold,” “working from home,” “creative task,” and “want to concentrate.” With the action suggestion display screen 3021, the user checks the action suggestion presented in response to the condition information input by the user and may try the action of the action suggestion.

Referring back to FIG. 13, the operation receiving unit 32 receives the input of the result information (step S38). Specifically, the operation receiving unit 32 receives the input of the result information to the communication terminal 3, which is input after the user presented with the specific action suggestion tries the action of the suggestion, for example.

A description will be given of an example of a display screen of the first embodiment for inputting the result information.

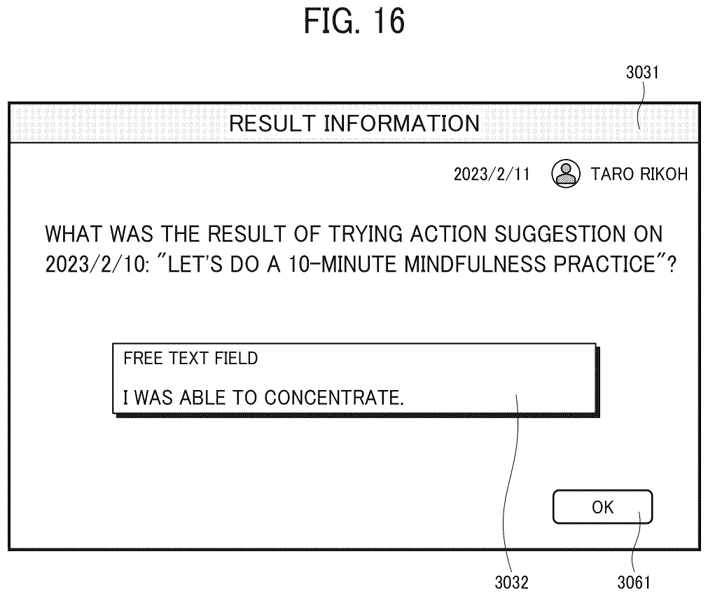

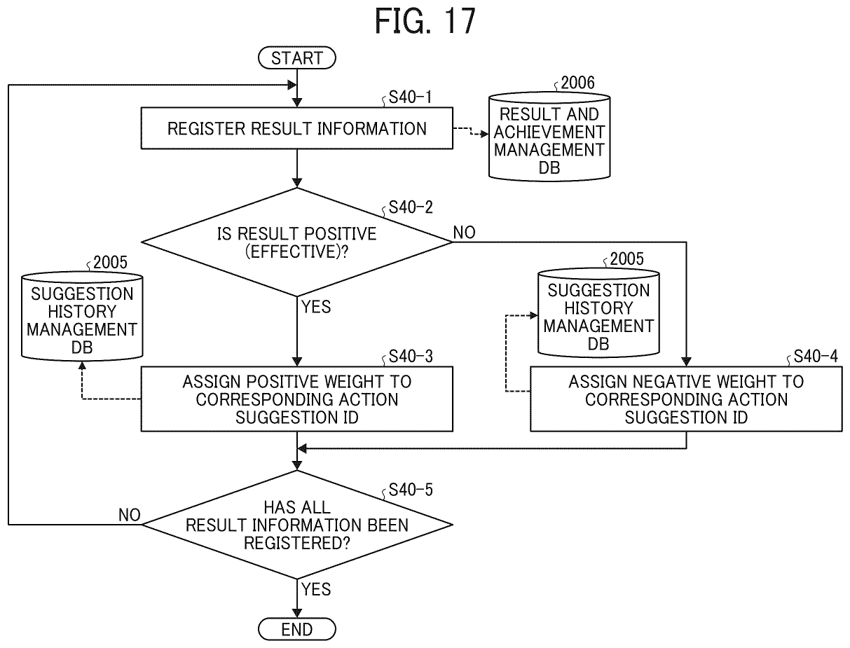

FIG. 16 is a diagram illustrating an example of the display screen of the first embodiment for inputting the result of the action. In FIG. 16, the display control unit 34 of the communication terminal 3 of the user causes the display 307 of the communication terminal 3 to display a result information display screen 3031. The result information display screen 3031 displays a free text field 3032 as well as the tile of the result information, the current date, the name of the user to whom the suggestion is presented, and a question about the result of the action taken in response to the action suggestion (e.g., the message “Let's do a 10-minute mindfulness practice”). The display control unit 34 further causes the display 307 to display an OK button 3061 in the result information display screen 3031. Then, the user Taro Rikoh enters text “I was able to concentrate,” for example, in the free text field 3032 as the result of the action based on the action suggestion “Let's do a 10-minute mindfulness practice” presented on 2023 Feb. 10 and operates the OK button 3061. Thereby, the communication terminal 3 is ready to transmit the result information input by the user Taro Rikoh to the action suggestion apparatus 2.

Referring back to FIG. 13, the transmitting and receiving unit 30 transmits a result information registration request to the action suggestion apparatus 2 (step S39). Thereby, the transmitting and receiving unit 20 of the action suggestion apparatus 2 receives the result information registration request transmitted by the communication terminal 3. The result information registration request transmitted in this step includes the result information input by the user in step S38.

Then, together with the generation unit 27, the registration unit 26 of the action suggestion apparatus 2 performs the result information registration and weighting process (step S40). Specifically, the registration unit 26 registers the result information and performs a weighting process. Then, the generation unit 27 generates the second suggestion information, which is new suggestion information for the action of the user according to the result information representing the result of the action of the user based on the first suggestion information generated in step S35.

If the user actually tries the action of the action suggestion presented to the user based on specific condition information, and if the user evaluates the action suggestion as effective, the generation unit 27 weights the action suggestion to gradually increase the possibility of the action suggestion being presented again when similar condition information is input. Conversely, if the user actually tries the action of the presented action suggestion but does not evaluate the action suggestion as effective, the generation unit 27 weights the action suggestion to gradually lower the possibility of the action suggestion being presented again.

Further, if a plurality of action suggestions include a suggestion of an action frequently selected and tried by the user, the generation unit 27 weights the suggestion to increase the possibility of a similar type of action being suggested. For example, if the user often selects actions involving physical exertion, the generation unit 27 makes adjustments to increase suggestions of actions involving physical exercise or workout.

Further, with the action suggestion apparatus 2 learning the feedback of action results with the action suggestion program, the generation unit 27 is expected to optimize the suggestions for the individual user.

In the process of step S40, based on the feedback from the user, the generation unit 27 may suggest an action considered to be effective for the user in a specific situation to another user placed in a similar situation. That is, if a certain user is similar to another user in the attributes or the condition information, the generation unit 27 may take account of the result information of the another user in presenting a suggestion to the certain user. For example, people similar in an attribute such as age or gender, the task condition such as the schedule, or the physical condition such as the pattern of changes in the physical condition are expected to have a positive result by taking a similar action. When searching for and suggesting a new action to a user, therefore, the action suggestion apparatus 2 may preferentially suggest an action that seems to be effective for another user who is similar to the user, as well as suggesting a random action.

The result information registration and weighting process of step S40 will be described in detail.

FIG. 17 is a flowchart illustrating an example of the result information registration and weighting process of the first embodiment. The flowchart described below is an example illustrating the embodiment and does not limit the result information registration and weighting process.

The registration unit 26 first registers the result information (step S40-1). Specifically, the registration unit 26 registers the result information received in step S39 of FIG. 13 into an item managed in the result and achievement management DB 2006 (see FIG. 11) and corresponding to the user ID and the date of input of the result information. In this case, the registration unit 26 registers the text “I was able to concentrate” input by the user Taro Rikoh in the item corresponding to the user ID “U0101” and the date “2023 Feb. 10,” for example.

Then, the determination unit 25 determines whether the result is positive (effective) (step S40-2). Specifically, the determination unit 25 determines whether the text information included in the result information registered in step S40-1 includes a positive message (comment) on the suggestion. In this determination process, the action suggestion apparatus 2 may use a machine learning model.

If it is determined that the result is positive (effective) (YES at step S40-2), the calculation unit 23 assigns a positive weight to the corresponding action suggestion ID (step S40-3). Specifically, the calculation unit 23 adds a plus sign “+” next to the action suggestion ID (e.g., “P0001” on 2023 Feb. 10) managed in the suggestion history management DB 2005 (see FIG. 10) and generated as an action suggestion in an item of the suggestion history by date associated with the user ID and the corresponding date. In this step, the generation unit 27 may generate the second suggestion information as new suggestion information.

If it is determined that the result is not positive (not effective) (NO at step S40-2), on the other hand, the calculation unit 23 assigns a negative weight to the corresponding action suggestion ID (step S40-4). Specifically, the calculation unit 23 assigns a minus sign “−” next to the action suggestion ID (e.g., “P0002” on 2023 Feb. 14) managed in the suggestion history management DB 2005 (see FIG. 10) and generated as an action suggestion in an item of the suggestion history by date associated with the user ID and the corresponding date. In this step, the generation unit 27 may generate the second suggestion information as new suggestion information similarly as in the process of step S40-3.

Then, the determination unit 25 determines whether all result information has been registered (step S40-5). If it is determined that all result information has been registered (YES at step S40-5), the determination unit 25 completes the procedure of FIG. 17. If it is determined that all result information has not been registered (NO at step S40-5), the determination unit 25 returns to the process of step S40-1 to repeat the subsequent processes.

The result information registration and weighting process illustrated in the flowchart of FIG. 17 may be executed for each of the dates of suggestions and for each of the suggestions to the users.

Referring back to FIG. 13, the generation unit 27 updates the machine learning model (step S41). Specifically, based on the result information registration and weighting process executed in step S40, the generation unit 27 updates the machine learning data of the user managed in the storage unit 2000 in accordance with the latest result information corresponding to the action suggestion. Consequently, the action suggestion apparatus 2 updates the suggestion according to the condition information input for the individual user, to thereby manage a new and more appropriate suggestion for the user.

Then, the transmitting and receiving unit 20 transmits a result information registration response to the communication terminal 3 as a response to the result information registration request (step S42). Thereby, the transmitting and receiving unit 30 of the communication terminal 3 receives the result information registration response transmitted by the action suggestion apparatus 2. The process of step S42 may be omitted.

The generation unit 27 may generate the same suggestion information as the first suggestion information generated in step S35 and the second suggestion information generated in step S40, to thereby avoid possible influence of a change in the suggestion information on the action of the user.

In the sequence diagram of FIG. 13, the generation unit 27 may generate the second suggestion information for each user by performing a process of increasing or lowering the priority of the first suggestion information being generated again in accordance with the result information corresponding to the first suggestion information generated for the user.

The generation unit 27 may further generate the second suggestion information by weighting the first suggestion information to increase the priority of the first suggestion information being generated again when the result information represents a positive result and weighting the first suggestion information to lower the priority of the first suggestion information being generated again when the result information represents a negative result.

As well as pursing the optimal solution for each user, as described above, the action suggestion system 1 also suggests an action to the user with particular frequency even if the action has not been previously found effective or selected by the user. Thereby, the action suggestion system 1 prevents the actions of the user from becoming routine and continues to provide the user with opportunities to explore and try new actions even if changes occur in the career, views, and preferences of the user, for example, over the course of using the action suggestion system 1.

A description will be given of an example using the action suggestion system 1 (hereinafter referred to as the first example).

In the first example, a user A starts using the action suggestion system 1 for the first time. One day, the user A uses the action suggestion system 1 in a lunch break to utilize 15 minutes after lunch and before the start of afternoon work. The user A selects and inputs “normal” as the physical condition, “working from home” as the execution condition, and “want to be creative” as the goal condition. In response to the input, the action suggestion system 1 outputs three action suggestions: (1) listening to B-flat major cinema music for five minutes, (2) going outside and taking a 5-minute walk, and (3) writing down on paper as many world heritage sites you have visited as possible in three minutes. Each of the three action suggestions is presented with a link to academic explanation supporting the suggestion. The user A selects the action of the suggestion (1), presses a play button displayed on the communication terminal 3, listens to the music, and starts the afternoon work. In a meeting in the afternoon, the user A finds himself producing fresh ideas and achieving productive results, which he attributes to the thought-activating effect of major-key music. The user A then inputs, as the result information, a comment that he finds the action of the selected suggestion (1) effective.

With this result information, the action suggestion apparatus 2 stores the selected action and the result thereof in the storage unit 2000, and generates a machine learning model in which the action suggestion of listening to music is weighted such that the probability of outputting this action suggestion as the action suggestion to the user A is 1.1 times higher than in a previous machine learning model.

Since then, the user A continues to use the action suggestion system 1 once or twice a day every day, immediately before the start of morning work, during lunch break, or between meetings in the afternoon, for example, to keep trying actions for improving work efficiency. The user A further tries mindfulness practice for the first time since starting using the action suggestion system 1. Not feeling the effect of the mindfulness practice from the first two or three trials, the user A inputs a comment “I felt no change” as the result information. Having been interested in mindfulness, however, the user A continues to select and try the mindfulness practice each time the action suggestion system 1 suggests the action. Then, after repeated trials, the user A gradually starts to feel the effect of the mindfulness practice on improving concentration. As the user A continues to input the result information, the probability of the mindfulness practice being suggested is increased under a certain condition in which the mindfulness practice has been found effective for the user A.

The action suggestion apparatus 2 keeps optimizing the conditions for the user A, such as the condition in which aromatherapy is effective for the user A and the condition in which applying warm masks on the eyes is effective for the user A, with the machine learning model daily learning the changes in the action selection by the user A and the result information. Consequently, the user A repeats a cycle of using the action suggestion system 1 with preferred timing suitable for his work schedule and acting in accordance with the suggestions presented by the action suggestion system 1, thereby attaining improved productivity and a stable state of body and mind.

Similarly to the user A, a user B different from the user A feels the creativity-enhancing effect of listening music. The user B, however, fails to feel the concentration-improving effect of the mindfulness practice after a few attempts, and thus inputs, as the result information, a comment that the mindfulness practice sometimes makes her sleepy, producing a counterproductive result. As a result, the mindfulness practice starts to be suggested less frequently, whereas physical activities such as short-time strength training start to be suggested more frequently. The user B finds activities involving physical exertion more suited for her to improve efficiency, and starts to be presented with action suggestions optimized for the user B. Consequently, the user B attains improved daily productivity and increased work satisfaction and achievement by using the action suggestion system 1, similarly as in the case of the user A.

As described above, according to the first embodiment, the action suggestion apparatus 2 generates the first suggestion information for the action based on the condition information of the user transmitted by the communication terminal 3 (step S35) and transmits the first suggestion information to the communication terminal 3 (step S36). The action suggestion apparatus 2 then generates the second suggestion information for the action of the user in accordance with the result information transmitted by the communication terminal 3, which represents the result of the action taken by the user based on the first suggestion information (step S40). Thereby, the suggestion information for the action of the user is adjusted to be appropriate to the state of the user.

Further, with the input of the ever-changing task situation of the individual user and the physical and mental information related to the physical and mental conditions of the user as part of the condition information, the action suggestion apparatus 2 optimizes the action suggestion in accordance with the situation of the user when the user is available to do some action. That is, the action suggestion system 1 optimizes the action suggestion in accordance with the situation of the user.

Further, with the action suggestion program learning the feedback of action results, the action suggestion apparatus 2 optimizes the action suggestion for the individual user, making the action suggestion more likely to more effective for the user. That is, the action suggestion system 1 optimizes the action suggestion in accordance with the individual user.

Furthermore, based on the feedback from users, the action suggestion apparatus 2 suggests an action expected to be effective for a certain user in a specific situation to another user placed in a similar condition, thereby presenting a new action suggestion to the another user. That is, the action suggestion system 1 explores better actions to suggest to users.

A second embodiment of the present invention will be described.

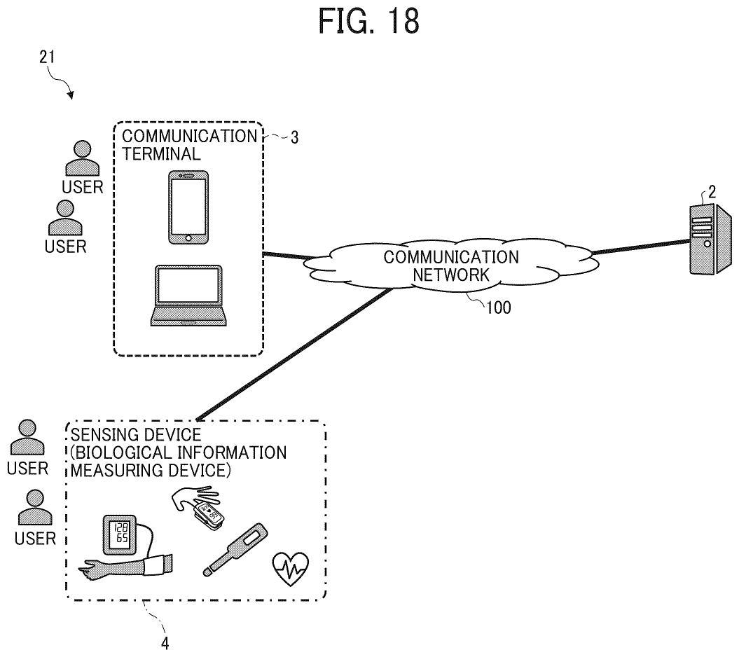

FIG. 18 is a diagram illustrating an exemplary general arrangement of an action suggestion system of the second embodiment. As illustrated in FIG. 18, the following description of the second embodiment will be given of a system configuration example of an action suggestion system 21 including a user-wearable sensing device 4 in addition to the communication terminal 3. The sensing device 4 has a function of transmitting to the action suggestion apparatus 2 the physical and mental information representing the physical and mental state of the user. To simplify the action suggestion system 21 of the second embodiment, therefore, the action suggestion system 21 may use the physical and mental information from the sensing device 4 alone, instead of using the communication terminal 3.

The sensing device 4 is a device used to infer the physical or mental state of the user from information such as eye gaze, blinking, heartbeat, respiration, body temperature, and body movement. That is, these types of information from the sensing device 4 are combined to reduce the man-hours for the user to input the conditions. In the second embodiment, data acquired by the sensing device 4 is converted into the condition information of the user. Similarly, to obtain the environmental condition, the action suggestion system 21 may be connected to devices such as a hygro-thermometer and a noise meter installed inside or outside an office or other work area, to thereby present an action suggestion appropriate to the environment of the user.

The sensing device 4 is implemented by one or more information processing apparatuses (i.e., computer systems) equipped with a typical server OS, for example. The sensing device 4 is a component forming the action suggestion system 21. A communication application for communicating with the action suggestion apparatus 2, for example, is installed and stored in storage means of the sensing device 4.

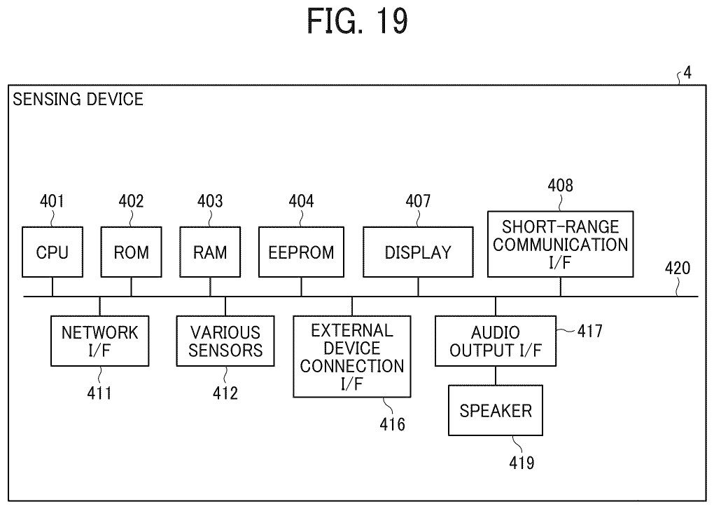

A hardware configuration of the sensing device 4 forming the action suggestion system 21 of the second embodiment will be described with FIG. 19. In the hardware configuration of the sensing device 4 illustrated in FIG. 19, a component may be added or deleted as necessary. The hardware configurations of the action suggestion apparatus 2 and the communication terminal 3 forming the action suggestion system 21 illustrated in FIG. 18 are similar to those described in the first embodiment, and thus description thereof will be omitted.

FIG. 19 is a diagram illustrating an exemplary hardware configuration of the sensing device 4 of the second embodiment. As illustrated in FIG. 19, the sensing device 4, which is implemented by a computer, for example, includes a CPU 401, a ROM 402, a RAM 403, an EEPROM 404, a display 407, a short-range communication I/F 408, a network I/F 411, various sensors 412, an external device connection I/F 416, an audio output I/F 417, a speaker 419, and a bus line 420.

The CPU 401 controls overall operation of the sensing device 4. The ROM 402 stores a program used to drive the CPU 401, for example. The RAM 403 is used as a work area of the CPU 401. The EEPROM 404 writes and reads various data such as applications under the control of the CPU 401. The display 407 displays various information such as a cursor, menus, windows, text, and images. The short-range communication I/F 408 is a communication circuit with a wireless communication interface conforming to a standard such as NFC, Bluetooth®, or Wi-Fi® to perform data communication with a communication device or terminal.

The network I/F 411 is an interface for performing data communication via the communication network 100. The various sensors 412 include sensors used to infer the physical or mental state of a person (i.e., a user) from eye gaze, blinking, heartbeat, respiration, body temperature, or body movement, for example. Specifically, the various sensors 412 may include a temperature sensor, a humidity sensor, a pulse sensor, a gas sensor, a photosensor, an acceleration sensor, a magnetic sensor, a pressure sensor, and a flow sensor, for example. The external device connection I/F 416 is an interface for connecting various external devices to the sensing device 4. The external devices may include a USB memory, for example. The audio output I/F 417 is a circuit that processes the output of audio signal to the speaker 419 under the control of the CPU 401. The speaker 419 is a built-in circuit that converts electrical signal into physical vibration to produce the sound of music or voice, for example. The bus line 420 includes address buses and data buses for electrically connecting the CPU 401 and the other components to each other.

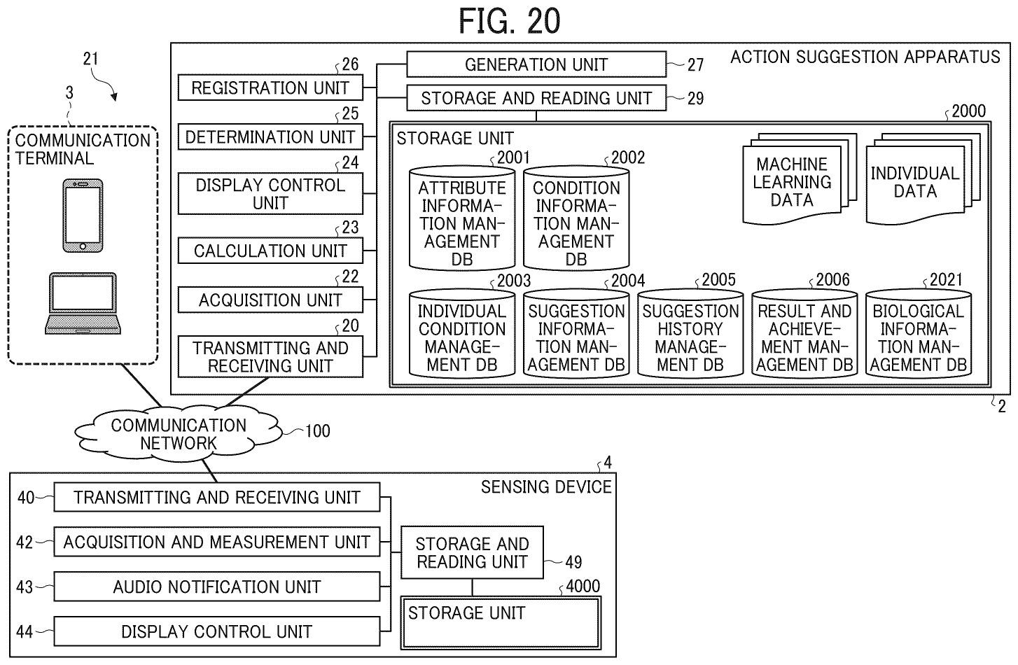

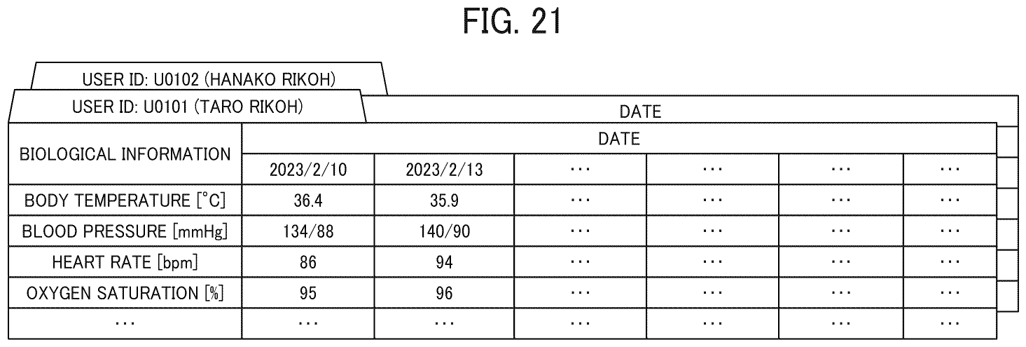

A functional configuration of the action suggestion system 21 of the second embodiment will be described with FIGS. 20 and 21. FIG. 20 is a diagram illustrating an exemplary functional configuration of the action suggestion system 21 of the second embodiment. FIG. 20 illustrates functional units of the action suggestion apparatus 2, the communication terminal 3, and the sensing device 4 illustrated in FIG. 18, specifically functional units thereof related to later-described processes or operations. The functional configuration of the communication terminal 3 of the second embodiment is similar to that of the first embodiment, and thus description thereof will be omitted.

The functional configuration of the action suggestion apparatus 2 of the second embodiment is similar to that of the first embodiment except for the addition of a data table described below, and thus description thereof will be omitted.

The data table managed in the action suggestion apparatus 2 of the second embodiment will be described.

FIG. 21 is a conceptual diagram illustrating an example of a biological information management table of the second embodiment. A data table described below is illustrative and does not limit the biological information management table. The storage unit 2000 stores a biological information management DB 2021 (see FIG. 20), which is implemented by the biological information management table illustrated in FIG. 21, for example. In the biological information management table, biological information and date are stored and managed in association with each other for each tab with a user ID. The biological information represents the biological information of the user, such as the body temperature, the blood pressure, the heart rate, and the oxygen saturation. The biological information may also include mental information representing the mental state of the user. The date represents the date of acquisition of the biological information. Each of the items of the biological information is managed to indicate which item of the biological information has been acquired.

In the second embodiment, the biological information management table (the biological information management DB 2021) functions as an example of biological information management means.

A functional configuration of the sensing device 4 will be described.

As illustrated in FIG. 20, the sensing device 4 includes a transmitting and receiving unit 40, an acquisition and measurement unit 42, an audio notification unit 43, a display control unit 44, and a storage and reading unit 49. Each of these functional units is a function or means implemented through the operation of one of the hardware resources illustrated in FIG. 19 based on a command from the CPU 401 in accordance with a program for the sensing device 4 deployed on the RAM 403 from at least one of the ROM 402 or the EEPROM 404. The sensing device 4 further includes a storage unit 4000, which is implemented by at least one of the ROM 402 or the EEPROM 404 illustrated in FIG. 19. The storage unit 4000 stores, for example, a browser application and a communication program (i.e., communication application) for communicating with the action suggestion apparatus 2 or the communication terminal 3 via the communication network 100.

The functional units of the sensing device 4 will be described in detail.

The transmitting and receiving unit 40 of the sensing device 4 illustrated in FIG. 20 is mainly implemented by the processing of the CPU 401 on the network I/F 411 and the short-range communication I/F 408. The transmitting and receiving unit 40 transmits and receives various data or information, such as the physical and mental information including the physical biological information and the mental information of the user, to and from the action suggestion apparatus 2 via the communication network 100. In the second embodiment, the transmitting and receiving unit 40 functions as an example of at least one of transmitting means or receiving means.

The acquisition and measurement unit 42 is mainly implemented by the processing of the CPU 401 on the various sensors 412. The acquisition and measurement unit 42 acquires the physical and mental information including the physical biological information and the mental information of the user. In the second embodiment, the acquisition and measurement unit 42 functions as an example of acquisition means.

The audio notification unit 43 is mainly implemented by the processing of the CPU 401 on the audio output I/F 417 and the speaker 419. The audio notification unit 43 outputs audio or sound information to send out detection signals or notifications of detected states detected by the various sensors 412, for example. In the second embodiment, the audio notification unit 43 functions as an example of notification means.

The display control unit 44 is mainly implemented by the processing of the CPU 401 on the display 407 of the sensing device 4. The display control unit 44 controls the display of various screens and information or data. The display control unit 44 may cause the display 307 of the communication terminal 3 to display the generated display screens in HTML with a browser, for example. In the second embodiment, the display control unit 44 functions as an example of display control means.

The storage and reading unit 49 is mainly implemented by the processing of the CPU 401 on at least one of the ROM 402 or the EEPROM 404. The storage and reading unit 49 stores various data or information in the storage unit 4000 and reads various data or information from the storage unit 4000. In the second embodiment, the storage and reading unit 49 functions as an example of storage and reading means.

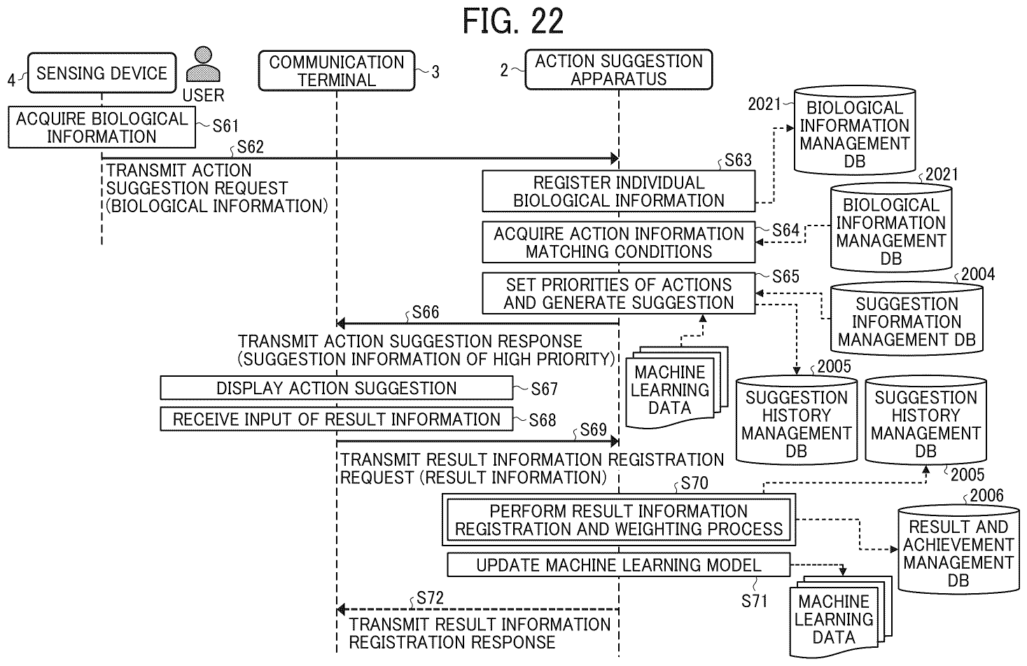

Processes or operations performed in the action suggestion system 21 of the second embodiment will be described with FIG. 22. An attribute information registration or update process of the second embodiment is similar to that of the first embodiment in FIG. 12, and thus description thereof will be omitted.

A process of registering various information will be described.

FIG. 22 is a sequence diagram illustrating an example of a result information registration and weighting process of the second embodiment. The acquisition and measurement unit 42 of the sensing device 4 first acquires the biological information of the user (step S61). In step S61, the acquisition and measurement unit 42 may acquire the physical and mental information including the mental information in addition to the physical biological information of the user.

The transmitting and receiving unit 40 then transmits an action suggestion request to the action suggestion apparatus 2 (step S62). Thereby, the transmitting and receiving unit 20 of the action suggestion apparatus 2 receives the action suggestion request transmitted by the sensing device 4. The action suggestion request transmitted in this step includes the current biological information of the user. The timing of transmitting the action suggestion request to the action suggestion apparatus 2 from the sensing device 4 may be determined based on the specifications of the action suggestion system 21; the action suggestion request may be transmitted at particular time intervals or when the biological information of the user changes by more than a certain threshold value, for example.

Then, the registration unit 26 of the action suggestion apparatus 2 registers individual biological information (step S63). Specifically, the registration unit 26 registers the biological information of the user received in step S62 into the corresponding items of the biological information in the biological information management DB 2021 (see FIG. 21).

The acquisition unit 22 then acquires the action information matching the conditions (step S64). Specifically, when there is biological information of the user transmitted by the sensing device 4 on a particular date, the acquisition unit 22 reads the biological information managed in the biological information management DB 2021 (see FIG. 21) and acquires therefrom items matching the items of the transmitted biological information. For example, the acquisition unit 22 and the storage and reading unit 29 acquire a body temperature “36.4° C.” and a blood pressure “134/88 mmHg,” for example, as the biological information of the user Taro Rikoh on 2023 Feb. 10. The data acquired by the sensing device 4 is then converted into the condition information of the user. Then, the converted data is processed as data for setting the priorities of the actions of the user and generating the action suggestion.

The subsequent processes of steps S65 to S72 are similar to those of steps S35 to S42 of FIG. 13 described in the first embodiment, and thus description thereof will be omitted.

In the action suggestion system 21 of the second embodiment, another device or apparatus may exist between the sensing device 4 and the action suggestion apparatus 2 in the execution of the above-described processes of step S62, for example. That is, the information or data transmitted and received between the sensing device 4 and the action suggestion apparatus 2 may be relayed by another device or apparatus. The above-described configuration is also applicable to a case where there is another processing step between the sensing device 4 and the action suggestion apparatus 2.

A description will be given of an example using the action suggestion system 21 (hereinafter referred to as the second example).

In the second example, a female user C, who often works from home, connects a digital thermo-hygro-barometer installed in her home office to the action suggestion system 21 of the second embodiment. The user C uses the action suggestion system 21 every day with her preferred timing to take breaks and do conditioning work. The user C has mild premenstrual syndrome (PMS) symptoms, which do not require medical treatment but cause her premenstrual migraine and sleepiness and thus an undesired decline in productivity. Over the course of using the action suggestion system 21, the user C starts to be presented with suggestions for conditioning that fine-tunes her physical condition, which keeps changing delicately depending on the season and the type of task on which she is working. The user C finds it effective to do a 10-minute Pilates exercise when not feeling well due to PMS; the user C feels a decent effect of doing the exercise.

The result and achievement management DB 2006 (see FIG. 11) stores the result information of all users with personal information of the users deleted or anonymized. The accumulated result information of the users includes many results and achievements by other women with PMS. The result information includes many cases in which a user similar in age to the user C and often working from home restores the physical condition and productivity by taking power nap in break time, and taking power nap is particularly effective in alleviating headaches.

One day, the barometer in the home office of the user C indicates a low pressure value with low atmospheric pressure approaching, and information “low atmospheric pressure” is automatically input as the environmental condition. Upon this input, power nap is suggested to the user C as a new action suggestion. Although the user C has no habit of taking power naps, she tries power nap during the last 15 minutes of her lunch break after reading and being convinced by a reason for the suggestion, which is based on data indicating that power nap is effective for women of similar age to her. Consequently, the user C avoids the migraine due to low atmospheric pressure and suffers less from the sleepiness associated with PMS, thereby efficiently carrying out afternoon work.

As described above, according to the second embodiment, the action suggestion apparatus 2 generates the first suggestion information for the action based on the physical and mental information including the biological information of the user transmitted by the sensing device 4 (step S65). Thereby, the second embodiment reduces the man-hours for the user to input the condition information, in addition to adjusting the suggestion information for the action of the user to be appropriate to the state of the user.

Further, the second embodiment is expected to prevent the user from inputting false condition information from a psychological desire to save face. Thereby, true physical and mental information of the user at a given time is obtained, allowing the action suggestion apparatus 2 to present a more accurate (appropriate) action suggestion for the action of the user.

A third embodiment of the present invention will be described.

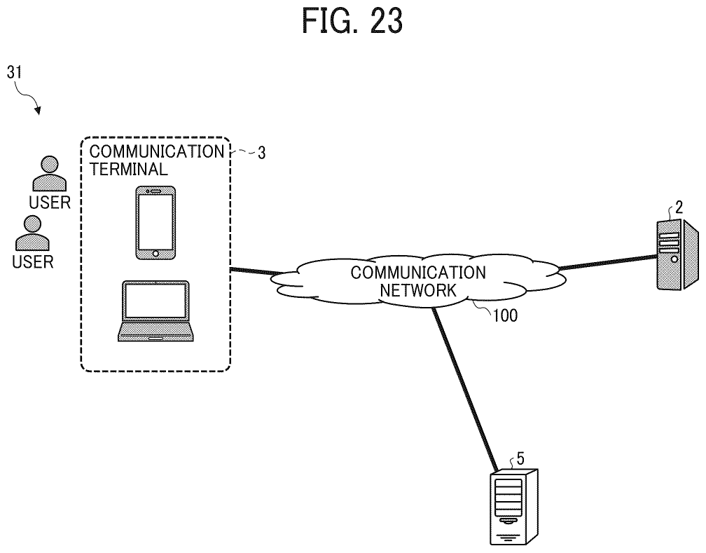

FIG. 23 is a diagram illustrating an exemplary general arrangement of an action suggestion system of the third embodiment. As illustrated in FIG. 23, the following description of the third embodiment will be given of a system configuration example of an action suggestion system 31 including, in addition to the communication terminal 3, a schedule management server 5 that manages the schedule of the user. The schedule management server 5 has a function of transmitting to the action suggestion apparatus 2 schedule information related to the event schedule of the user, for example. To simplify the action suggestion system 31 of the third embodiment, therefore, the action suggestion system 31 may use the schedule information from the schedule management server 5 alone, instead of using the communication terminal 3.

In the third embodiment, the user may select an option of allowing the action suggestion apparatus 2 to automatically acquire or infer and input the physical condition, the mental condition, the task condition, and the execution condition of the user by analyzing information from the schedule management server 5.

Specifically, the action suggestion apparatus 2 may infer the conditions based on past experiences. For example, the action suggestion apparatus 2 may predict mental fatigue or impaired concentration of the user when the user is scheduled to have a series of meetings over a long period of time. To make more accurate predictions based on the task and the physical constitution of the user, machine learning such as neural networking illustrated in FIG. 2A may be used to perform learning by setting the schedule information of the user (e.g., how filled the daily schedule is, the type of task, and the work hours) as the input layer, and setting the corresponding physical and mental conditions of the user as the output layer. Thereby, the condition of the user is predicted from his or her schedule on a given day.

The action suggestion apparatus 2 may further acquire the task condition predictable from the subsequent schedule and the execution condition such as the duration of free time or whether the user is scheduled to move between places, for example, to reduce the man-hours for the user to input the conditions.

The schedule management server 5 is a server (apparatus) that electronically manages the event schedule of the user, for example. With the schedule management server 5, the man-hours for the user to input the conditions are reduced. In the third embodiment, data acquired by the schedule management server 5 is converted into the condition information of the user. The schedule management server 5 may be a commonly used server capable of registering and managing the schedule of the user as a timetable.

The schedule management server 5 is implemented by one or more information processing apparatuses (i.e., computer systems) equipped with a typical server OS, for example. The schedule management server 5 is a component forming the action suggestion system 31. A communication application for communicating with the action suggestion apparatus 2, for example, is installed and stored in storage means of the schedule management server 5.

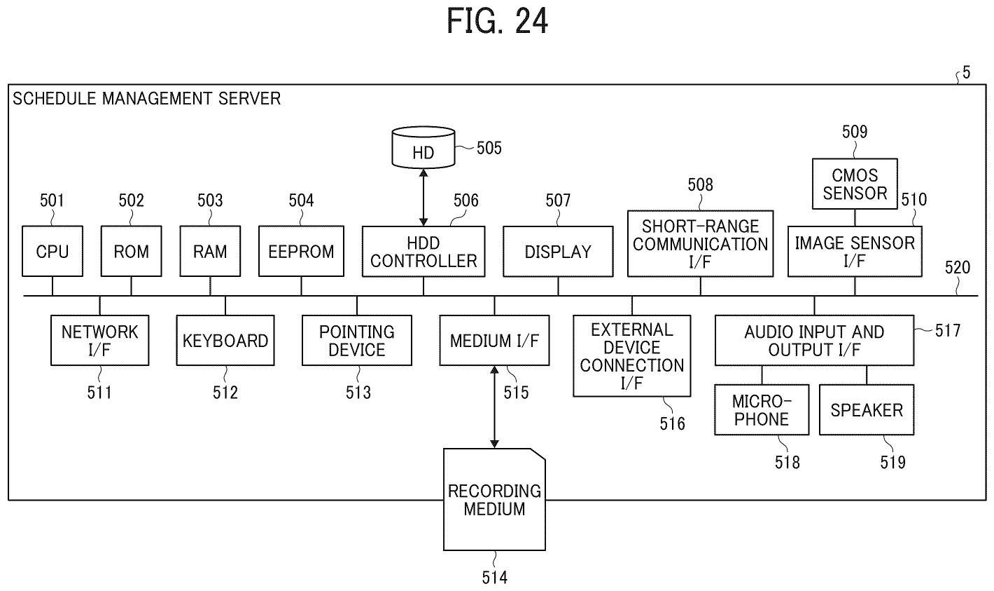

A hardware configuration of the schedule management server 5 forming the action suggestion system 31 of the third embodiment will be described with FIG. 24. In the hardware configuration of the schedule management server 5 illustrated in FIG. 24, a component may be added or deleted as necessary. The hardware configurations of the action suggestion apparatus 2 and the communication terminal 3 forming the action suggestion system 31 illustrated in FIG. 23 are similar to those described in the first embodiment, and thus description thereof will be omitted.

FIG. 24 is a diagram illustrating an exemplary hardware configuration of the schedule management server 5 of the third embodiment. As illustrated in FIG. 24, the schedule management server 5, which is implemented by a computer, for example, includes a CPU 501, a ROM 502, a RAM 503, an EEPROM 504, an HD 505, an HDD controller 506, a display 507, a short-range communication I/F 508, a CMOS sensor 509, an image sensor I/F 510, a network I/F 511, a keyboard 512, a pointing device 513, a medium I/F 515, an external device connection I/F 516, an audio input and output I/F 517, a microphone 518, a speaker 519, and a bus line 520. The hardware resources of the schedule management server 5 are the same as those of the action suggestion apparatus 2 described in the first embodiment, and thus description thereof will be omitted.

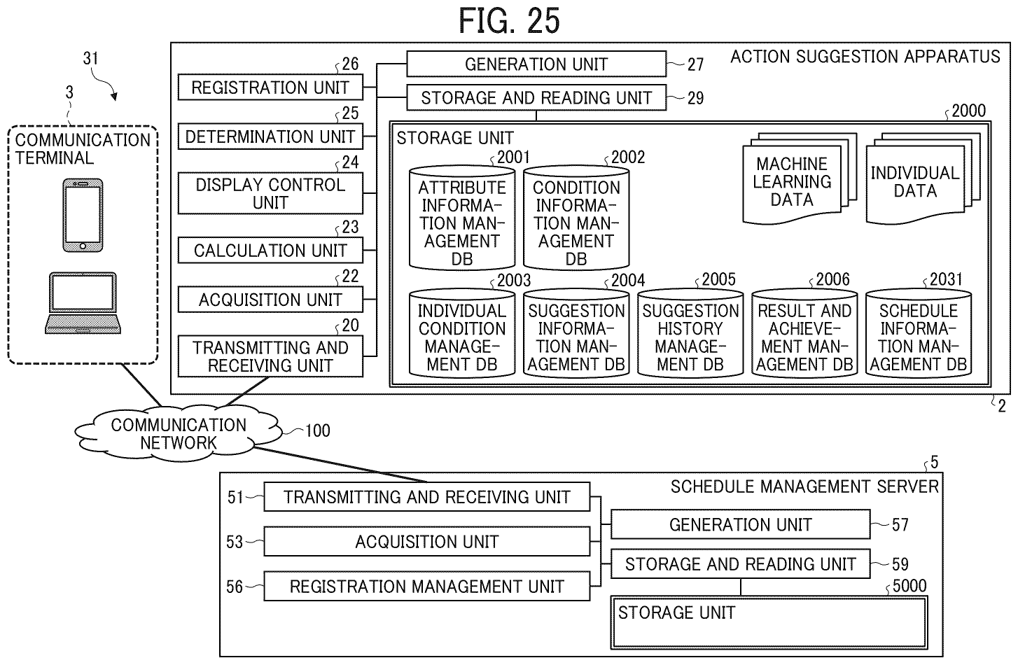

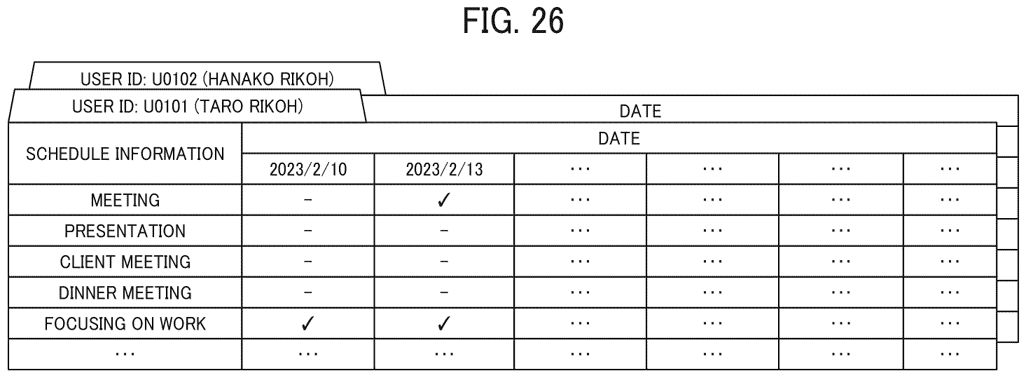

A functional configuration of the action suggestion system 31 of the third embodiment will be described with FIGS. 25 and 26.

FIG. 25 is a diagram illustrating an exemplary functional configuration of the action suggestion system 31 of the third embodiment. FIG. 25 illustrates functional units of the action suggestion apparatus 2, the communication terminal 3, and the schedule management server 5 illustrated in FIG. 23, specifically functional units thereof related to later-described processes or operations. The functional configuration of the communication terminal 3 of the third embodiment is the same as that of the first embodiment, and thus description thereof will be omitted.

The functional configuration of the action suggestion apparatus 2 of the third embodiment is the same as that of the first embodiment except for the addition of a data table described below, and thus description thereof will be omitted.

The data table managed in the action suggestion apparatus 2 of the third embodiment will be described.

FIG. 26 is a conceptual diagram illustrating an example of a schedule information management table of the third embodiment. A data table described below is illustrative and does not limit the schedule information management table. The storage unit 2000 storers a schedule information management DB 2031 (see FIG. 25), which is implemented by the schedule information management table illustrated in FIG. 26, for example. In the schedule information management table, the schedule information and the date are stored and managed in association with each other for each tab with a user ID. The schedule information is the information of events in which the user is scheduled to participate, such as meeting, presentation, client meeting, dinner meeting, and focusing on work. The schedule information may also include an event associated with personal feeling or action of the user (e.g., nap or rest). The date represents the date of acquisition of the schedule information. Each of the items of the schedule information is managed with a checkmark or a dash sign, for example to indicate which item of the schedule information has been acquired. The checkmark indicates that the corresponding schedule information item has been acquired, and the dash sign indicates that the corresponding schedule information item has not been acquired.

In the third embodiment, the schedule information management table (the schedule information management DB 2031) functions as an example of schedule information management means.

A functional configuration of the schedule management server 5 will be described.

As illustrated in FIG. 25, the schedule management server 5 includes a transmitting and receiving unit 51, an acquisition unit 53, a registration management unit 56, a generation unit 57, and a storage and reading unit 59. Each of these functional units is a function or means implemented through the operation of one of the hardware resources in FIG. 24 based on a command from the CPU 501 in accordance with a program for the schedule management server 5 deployed on the RAM 503 from at least one of the ROM 502, the EEPROM 504, the HD 505, or a recording medium 514. The schedule management server 5 further includes a storage unit 5000 implemented by at least one of the ROM 502, the EEPROM 504, the HD 505, or the recording medium 514 illustrated in FIG. 24. The storage unit 5000 stores, for example, a browser application and a communication program (i.e., communication application) for communicating with the action suggestion apparatus 2 or the communication terminal 3 via the communication network 100.

The functional units of the schedule management server 5 will be described in detail.

The transmitting and receiving unit 51 of the schedule management server 5 illustrated in FIG. 25 is mainly implemented by the processing of the CPU 501 on the network I/F 511 and the short-range communication I/F 508. The transmitting and receiving unit 51 transmits and receives various data or information related to the schedule of the user to and from the action suggestion apparatus 2 via the communication network 100. In the third embodiment, the transmitting and receiving unit 51 functions as an example of at least one of transmitting means or receiving means.

The acquisition unit 53 is mainly implemented by the processing of the CPU 501. The acquisition unit 53 acquires the schedule information of the user. In the third embodiment, the acquisition unit 53 functions as an example of acquisition means.

The registration management unit 56 is mainly implemented by the processing of the CPU 501. The registration management unit 56 registers and manages the schedule information of the user. In the third embodiment, the registration management unit 56 functions as an example of registration means and an example of management means.

The generation unit 57 is mainly implemented by the processing of the CPU 501. The generation unit 57 generates various information to be transmitted to the action suggestion apparatus 2. In the third embodiment, the generation unit 57 functions as an example of generation means.

The storage and reading unit 59 is mainly implemented by the processing of the CPU 501 on at least one of the ROM 502, the EEPROM 504, the HD 505, or the recording medium 514. The storage and reading unit 59 stores various data or information in the storage unit 5000 and reads various data or information from the storage unit 5000. In the third embodiment, the storage and reading unit 59 functions as an example of storage and reading means.

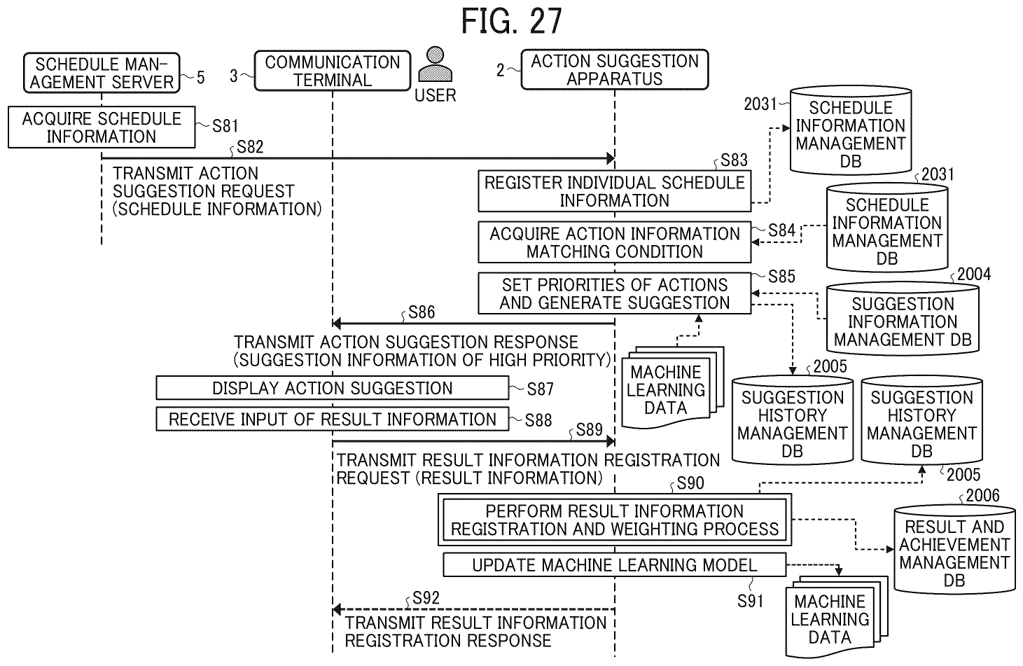

Processes or operations performed in the action suggestion system 31 of the third embodiment will be described with FIG. 27. An attribute information registration or update process of the third embodiment is similar to that of the first embodiment illustrated in FIG. 12, and thus description thereof will be omitted.

FIG. 27 is a sequence diagram illustrating an example of the attribute information registration or update process of the third embodiment. The acquisition unit 53 of the schedule management server 5 first acquires the schedule information of the user (step S81).

The transmitting and receiving unit 51 then transmits an action suggestion request to the action suggestion apparatus 2 (step S82). Thereby, the transmitting and receiving unit 20 of the action suggestion apparatus 2 receives the action suggestion request transmitted by the schedule management server 5. The action suggestion request transmitted in this step includes the schedule information of the user. The timing of transmitting the action suggestion request to the action suggestion apparatus 2 from the schedule management server 5 may be determined based on the specifications of the action suggestion system 31; the action suggestion request may be transmitted at particular time intervals or when a particular change occurs in the schedule information of the user, for example.

The registration unit 26 of the action suggestion apparatus 2 registers individual schedule information (step S83). Specifically, the registration unit 26 registers the schedule information of the user received in step S82 into the corresponding item of the schedule information in the schedule information management DB 2031 (see FIG. 26).

The acquisition unit 53 then acquires the action information matching the condition (step S84). Specifically, the acquisition unit 53 reads the items of the schedule information managed in the schedule information management DB 2031 (see FIG. 26) and acquires therefrom an item matching the schedule information of the user transmitted by the schedule management server 5 on a predetermined date. For example, the acquisition unit 53 and the storage and reading unit 59 acquire an item “focusing on work” marked with a checkmark as the schedule information of the user Taro Rikoh on 2023 Feb. 10. Then, the data acquired by the schedule management server 5 is converted into the condition information of the user. The converted data is then processed as data for setting the priorities of the actions of the user and generating the action suggestion.

The subsequent processes of step S85 to S92 are similar to those of steps S35 to S42 of FIG. 13 described in the first embodiment, and thus description thereof will be omitted.

In the action suggestion system 31 of the third embodiment, another device or apparatus may exist between the schedule management server 5 and the action suggestion apparatus 2 in the execution of the above-described process of step S82, for example. That is, the information or data transmitted and received between the schedule management server 5 and the action suggestion apparatus 2 may be relayed by another device or apparatus. The above-described configuration is also applicable to a case where there is another processing step between the schedule management server 5 and the action suggestion apparatus 2.

A description will be given of an example using the action suggestion system 31 (hereinafter referred to as the third example).

In the third example, a user D weekly attends a regular early morning meeting to talk with an overseas client. The meeting starts at 6:00 a.m. and is followed by other meetings, which fill the morning schedule. Although being aware of eye fatigue and mental stress building up by around lunch break, making afternoon work arduous, the user D habitually keeps working on the task at hand.

Therefore, the user D turns on a push notification function of the action suggestion system 31 to notify him of the time to take a break. On the day of the early morning meeting next week, the action suggestion system 31 causes a PC display of the user D to display a pop-up notification “Let's take a break” at 8:30 a.m. after the user D finishes 2.5-hour work by estimating, from the schedule information, the time when eye fatigue and productivity decline start to emerge. Reading a description that, based on his past data, taking a conditioning action with this timing is expected to make subsequent work less arduous and substantially improve productivity, the user D immediately takes his eyes off the PC and tries an action of resting for three minutes while sitting at a desk with a warm towel placed over closed eyes, which is one of actions suggested to the user D.

The user D finds that even the short 3-minute action is effective, enabling him to work efficiently for the rest of the morning and afternoon of that day. Since then, each time a notification suggesting resting or conditioning arrives, the user D stops an ongoing task and tries the suggested action. Eventually, the user D becomes able to work without getting easily exhausted or stressed out, thereby improving daily productivity and obtaining enhanced satisfaction and sense of achievement from work.

As described above, according to the third embodiment, the action suggestion apparatus 2 generates the first suggestion information for the action similarly as in the first embodiment but based on the schedule information of the user transmitted by the schedule management server 5 (step S85). Thereby, the third embodiment reduces the man-hours for the user to input the schedule information and thus reduces the workload on the user, in addition to adjusting the suggestion information for the action of the user to be appropriate to the state of the user.

A fourth embodiment of the present invention will be described.

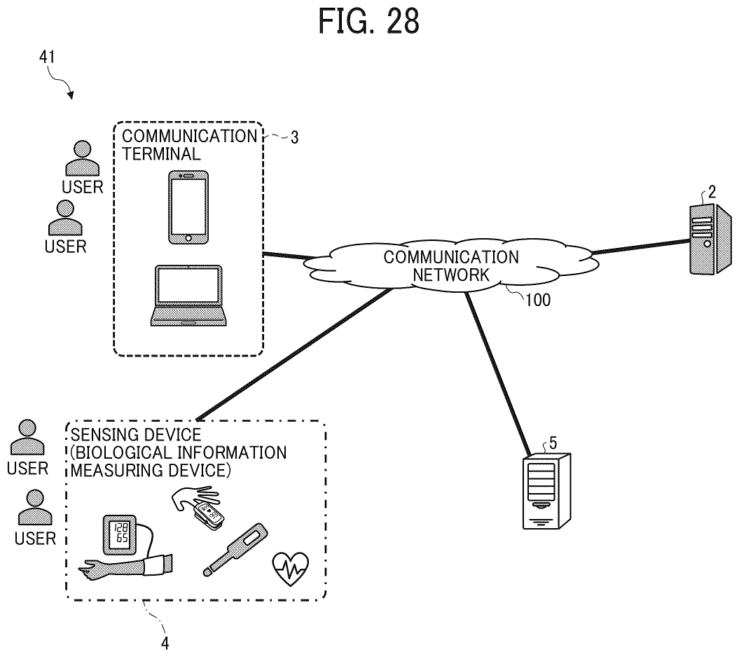

FIG. 28 is a diagram illustrating an example of the general arrangement of an action suggestion system of the fourth embodiment. As illustrated in FIG. 28, the following description of the fourth embodiment will be given of an example of an action suggestion system 41 including the sensing device 4 of the second embodiment and the schedule management server 5 of the third embodiment to present the action suggestion to the user. Therefore, the system configuration, hardware configuration, or functional configuration of the action suggestion system 41 of the fourth embodiment is a combination of the corresponding configurations of the second and third embodiments.

The user connects a biological information measuring device to the action suggestion system 41 as necessary. The biological information measuring device, such as a pulse meter, an electrocardiograph, a respiration sensor, or a body temperature sensor, acquires a barometer of autonomic nervous system activity to estimate the physical condition of the user, such as the degree of fatigue. The user wears the biological information measuring device or places the biological information measuring device near him or her as means for automatically inputting the information of the physical condition and the mental condition of the user. The user may also use a sensor for measuring the work environment (e.g., a thermometer, a hygrometer, or a noise meter) as means for automatically inputting the environmental condition or use a global positioning system (GPS) or an acceleration sensor, for example, as means for automatically inputting the execution condition by connecting the device to the action suggestion system 41.

The action suggestion apparatus 2 converts the data acquired from the sensing device 4 into the condition information inferred from the data. For example, the action suggestion apparatus 2 estimates the degree of fatigue of the user by analyzing heart rate fluctuation data acquired from the biological information measuring device, and automatically inputs an option of the physical condition such as “good,” “normal,” or “exhausted” and an option of the mental condition such as “good,” “normal,” or “irritable” as the condition information of the user when the user is using the action suggestion system 41.

The above-described condition information automatically input from the sensing device 4 may be directly used by the user or may be corrected by the user. If the user actually feels very exhausted even though the physical condition determined based on the biological information is “good,” the user may correct the physical condition to “exhausted.”

Similarly, the action suggestion apparatus 2 reflects the work environment-related data acquired by the sensing device 4 in the condition information to make the suggested action more appropriate to the situation of the user. For example, if the user has been working in a dry environment, the action suggestion apparatus 2 may preferentially suggest an action of taking in water, even though the user is unaware of having been exposed to dryness. The action suggestion apparatus 2 thus suggests an action appropriate to the user in a given situation without need for the user to input information or operate a device.

With locational information and acceleration data transmitted to the action suggestion system 41, the action suggestion apparatus 2 determines the weather, atmospheric pressure, and pollen count information of the place where the user is working, and determines whether the user is moving between places, for example. The action suggestion apparatus 2 reflects this information in the execution condition information to make the suggested action more appropriate to the situation of the user. For example, if the productivity of the user is normally improved after jogging for a few minutes for refreshment, but if it is raining in or near the location of the user when the user uses the action suggestion system 41, the action suggestion apparatus 2 suggests, instead of jogging, an alternative action performable indoors, for example. The action suggestion apparatus 2 thus suggests the action appropriate to the location of the user when the user uses the action suggestion system 41.

The condition information automatically input from the schedule management server 5 may also be corrected based on the actual feeling or experience of the user. The action suggestion system 41 keeps learning the differences between the values inferred by the action suggestion system 41 and the values input by the user to improve the accuracy of inference in accordance with the user.

The user may connect the schedule management server 5, i.e., a work management system that electronically manages the schedule, to the action suggestion system 41 as necessary to use the schedule management server 5 as means for automatically inputting the physical condition, the mental condition, the task condition, and the goal condition. The tightness of the schedule is considered to have a significant influence on the physical condition and the mental condition. If the schedule of the user includes a succession of meetings, therefore, “exhausted” is automatically input as the condition information.

Further, from a word or phrase in the description of an event in the schedule, the action suggestion apparatus 2 infers the task that is being performed or is scheduled to be performed in the time slot of the event, and inputs the inferred task as the task condition. The action suggestion apparatus 2 roughly infers the task condition. For example, from a phrase “attending a lecture,” the action suggestion apparatus 2 infers a passive task of listening to something such as a report. The action suggestion apparatus 2 further infers presentation from a word “report,” and infers discussion from a word “review” or “consultation,” for example. The action suggestion apparatus 2 may also automatically input the goal condition in accordance with the future schedule. For example, if the future schedule includes listening to a report, the action suggestion apparatus 2 may infer that the user desires to improve concentration. Further, if the future schedule includes delivering a report, the action suggestion apparatus 2 may infer that the user desires to relax to deliver the report with composure. Furthermore, if the future schedule includes having a discussion, the action suggestion apparatus 2 may infer that the user desires to be creative. The action suggestion apparatus 2 thereby optimizes the action suggestion to the user in a given situation, while minimizing the operations to be performed by the user.

As another application example of inferring the physical condition and the mental condition of the user, the action suggestion apparatus 2 may learn, as the output information, the result information of the user corresponding to the schedule information, as illustrated in FIG. 2B, to thereby infer a more effective timing for the user to take a certain action to ultimately enable the user to work in a favorable condition.

Further, with reference to the schedule of the user, the action suggestion apparatus 2 determines the optimal timing for the user to perform the action to do the work of a day more effectively or comfortably, and transmits a push notification to the communication terminal 3. Thereby, the user receives an appropriate action suggestion with appropriate timing, without having to plan the timing of taking a rest or action or input the condition information.

According to the above-described action suggestion method of the action suggestion system 41, the user receives the appropriate action suggestion according to the ever-changing task situation and physical and mental conditions of the user and performs the suggested action. Thereby, the user is able to perform the subsequent work more efficiently or comfortably with less fatigue or stress.

Processes or operations performed in the action suggestion system 41 of the fourth embodiment will be described. An attribute information registration or update process of the fourth embodiment is similar to that of the first embodiment illustrated in FIG. 12, and thus description thereof will be omitted.

A sequence diagram or flowchart illustrating a various information registration process of the fourth embodiment may be a combination of the sequence diagrams or flowcharts of the second and third embodiments.

A description will be given of an example using the action suggestion system 41 (hereinafter referred to as the fourth example).

In the fourth example, a male user E connects, to the action suggestion system 41 of the fourth embodiment, a pulse sensor in the form of a smartwatch for acquiring his biological information. The user E further sets the communication terminal 3 to be linked with the schedule management server 5. Since the morning schedule of the user E is often filled with incessant meetings, it matters for the user E to effectively use lunch break to do conditioning for the afternoon work. One day, the user E starts using the action suggestion system 41 after lunch. As the condition information of the user E inferred from the data of the pulse sensor and the schedule, the physical condition is determined to be “normal,” and the mental condition is determined to be “extremely exhausted.” Further, the user E is scheduled to carefully examine documents in the afternoon. Based on this information, the goal condition is automatically set to “want to concentrate.” The user E checks the automatically set goal condition and is presented with three action suggestions: drinking black coffee, doing yoga for five minutes, and relaxing while watching a video with natural scenery and sound.

The user E normally prefers tea with milk. After reading a description that the aroma of coffee affects the limbic system to reduce stress and improve information processing ability, however, the user E tries black coffee and feels slightly more progress in the afternoon work than usual. Since then, the user E continues to use the action suggestion system 41 every day in lunch break and another break around 3:00 μm. The user E repeats a cycle of performing the action suggested based on his condition information, which is automatically input from the sensing device 4 and the schedule management server 5 and corrected by the user E when necessary, and inputting the result information. Consequently, the action suggestion system 41 repeatedly acquires the result information input by the user E, thereby improving the accuracy of inferring the condition information based on the data from the sensing device 4 and the schedule management server 5, and enhancing the appropriateness of the action suggestion.

After the user E repeats the above-described cycle of actions for one month, the appropriateness of suggestions is improved enough for the user E to feel a definite increase in productivity by selecting and trying any one of the actions suggested by the action suggestion system 41. One day in the second month since starting using the action suggestion system 41, the user E plans to use the whole day to focus on work and finish preparing materials. The user E starts using the action suggestion system 41 before the start of the morning work, drinks black coffee, and starts working. In the machine learning model for the user E, which has learned a history of past achievements of the user E, drinking black coffee is an option of action most expected to improve productivity in both lunch break and afternoon break based on the degree of fatigue and the type of task of the user E on that day. The action suggestion system 41, however, has a limit in suggesting a caffeine intake action, and determines that, when the user E drinks black coffee in both morning and lunch time, drinking another coffee in the afternoon will result in exceeding a preferable caffeine intake amount and may disturb his sleep during the night.

As a result, the action suggestion system 41 avoids recommending black coffee in the afternoon of that day, and suggests peppermint aromatherapy instead. The user E selects this suggestion and works on preparing materials in a peppermint-scented room, consequently succeeding in finishing the task by the deadline. With the action suggestion system 41, the user E thus improves daily productivity and avoids the action that is expected to have a temporary effect of improving productivity but may harm his health in a long run. Consequently, the user E continues to work in an appropriate condition.

As described above, the action suggestion apparatus 2 may make various determinations with, for example, cosine similarity in machine learning with artificial intelligence (AI). The action suggestion apparatus 2 may use another analysis method in place of cosine similarity to classify documents.

The present disclosure relates to the following aspects, for example.

According to a first aspect, an action suggestion system 1 (an example of an action suggestion system) includes an action suggestion apparatus 2 (an example of an action suggestion apparatus) and a communication terminal 3 (an example of a communication terminal). The action suggestion apparatus 2 presents a suggestion for an action of a user. The communication terminal 3 is used by the user. The action suggestion apparatus 2 includes a transmitting and receiving unit 20 (an example of receiving means and an example of transmitting means) and a generation unit 27 (an example of generation means). The transmitting and receiving unit 20 receives condition information of the user from the communication terminal 3 used by the user. The generation unit 27 generates first suggestion information for the action of the user based on the received condition information. The transmitting and receiving unit 20 transmits the generated first suggestion information to the communication terminal 3 used by the user. The transmitting and receiving unit 20 receives, from the communication terminal 3, result information representing a result of the action of the user based on the first suggestion information. The generation unit 27 generates second suggestion information for the action of the user based on the received result information. The communication terminal 3 includes a display control unit 34 (an example of display control means) that causes a display 307 (an example of display means) to display the generated second suggestion information for the user.

According to the first aspect, the suggestion information for the action of the user is adjusted to be appropriate to the state of the user.

According to a second aspect, in the action suggestion system 1 of the first aspect, the condition information, based on which the generation unit 27 of the action suggestion apparatus 2 generates the first suggestion information, includes at least one of attribute information, physical and mental information, environmental information, or schedule information. The attribute information represents an attribute of the user. The physical and mental information is related to a body and mind of the user. The environmental information is related to an environment surrounding the user. The schedule information represents a schedule of the user.

According to the second aspect, a more appropriate action suggestion is provided based on more detailed information of the user, in addition to the adjustment of the suggestion information for the action of the user to be appropriate to the state of the user.

According to a third aspect, in the action suggestion system 1 of the first or second aspect, the generation unit 27 of the action suggestion apparatus 2 updates a particular machine learning model in accordance with the result information to generate the second suggestion information.

According to the third aspect, the machine learning model related to the action suggestion is updated to provide a new more appropriate action suggestion.

According to a fourth aspect, in the action suggestion system 1 of one of the first to third aspects, in accordance with the result information corresponding to the first suggestion information generated for the user, the generation unit 27 of the action suggestion apparatus 2 weights the first suggestion information and generates the second suggestion information for the user in accordance with the weighting.

According to the fourth aspect, an appropriate action suggestion is provided to the individual user.

According to a fifth aspect, in the action suggestion system 1 of the fourth aspect, when the result information represents a positive result, the generation unit 27 of the action suggestion apparatus 2 weights the first suggestion information to increase a priority of the first suggestion information being generated again, and generates the second suggestion information in accordance with the weighting. When the result information represents a negative result, the generation unit 27 weights the first suggestion information to lower the priority of the first suggestion information being generated again, and generates the second suggestion information in accordance with the weighting.

According to the fifth aspect, a more appropriate action suggestion is provided to the individual user.

According to a sixth aspect, in the action suggestion system 1 of the fifth aspect, when the first suggestion information is weighted to increase the priority of the first suggestion information being generated again, the generation unit 27 of the action suggestion apparatus 2 sets a limit in generating the second suggestion information in accordance with the weighting in order to generate the second suggestion information in accordance with physical and mental information of the user.

According to the sixth aspect, an appropriate action suggestion is provided in accordance with the physical and mental state of the user.

According to a seventh aspect, in the action suggestion system 1 of one of the second to sixth aspects, the generation unit 27 of the action suggestion apparatus 2 weights the first suggestion information based on information including other result information of another user whose attribute information is similar to attribute information of the user.

According to the seventh aspect, the another user with the attribute information similar to the attribute information of the user is provided with an action suggestion similar to the action suggestion provided to the user. Consequently, the processing efficiency of the action suggestion apparatus 2 is improved.

According to an eighth aspect, in the action suggestion system 1 of one of the first to seventh aspects, the transmitting and receiving unit 20 of the action suggestion apparatus 2 transmits the first suggestion information to the communication terminal 3 with particular timing according to the condition information and the result information of the user.

According to the eighth aspect, the user of the communication terminal 3 receives the action suggestion to the user with appropriate timing.

According to a ninth aspect, in the action suggestion system 1 of one of the first to eighth aspects, the generation unit 27 of the action suggestion apparatus 2 generates same suggestion information as the first suggestion information and the second suggestion information.

According to the ninth aspect, when it is determined desirable not to change the suggestion information to the user, the same suggestion information is provided to the user to minimize mental stress or influence on the user.

According to a tenth aspect, an action suggestion apparatus 2 (an example of an action suggestion apparatus) includes a transmitting and receiving unit 20 (an example of receiving means and an example of transmitting means) and a generation unit 27 (an example of generation means). The action suggestion apparatus 2 presents a suggestion for an action of a user. The transmitting and receiving unit 20 receives condition information of the user from a communication terminal 3 used by the user. The generation unit 27 generates first suggestion information for the action of the user based on the received condition information. The transmitting and receiving unit 20 transmits the generated first suggestion information to the communication terminal 3 used by the user. The transmitting and receiving unit 20 receives, from the communication terminal 3, result information representing a result of the action of the user based on the first suggestion information. The generation unit 27 generates second suggestion information for the action of the user in accordance with the received result information.

According to the tenth aspect, the suggestion information for the action of the user is adjusted to be appropriate to the state of the user similarly as in the first aspect.

According to an eleventh aspect, an action suggestion method is performed by an action suggestion apparatus 2 (an example of an action suggestion apparatus) that presents a suggestion for an action of a user. The action suggestion method includes receiving condition information of the user from a communication terminal 3 used by the user, generating first suggestion information for the action of the user based on the received condition information, and transmitting the generated first suggestion information to the communication terminal 3 used by the user. The receiving includes receiving result information representing a result of the action of the user based on the first suggestion information. The generating includes generating second suggestion information for the action of the user in accordance with the received result information.

According to the eleventh aspect, the suggestion information for the action of the user is adjusted to be appropriate to the state of the user similarly as in the first aspect.

According to a twelfth aspect, a non-transitory recording medium stores a plurality of instructions which, when executed by one or more processors, causes the one or more processors to perform an action suggestion method. The action suggestion method is performed by an action suggestion apparatus 2 (an example of an action suggestion apparatus) that presents a suggestion for an action of a user. The action suggestion method includes receiving condition information of the user from a communication terminal 3 used by the user, generating first suggestion information for the action of the user based on the received condition information, and transmitting the generated first suggestion information to the communication terminal 3 used by the user. The receiving includes receiving result information representing a result of the action of the user based on the first suggestion information. The generating includes generating second suggestion information for the action of the user in accordance with the received result information.

According to the twelfth aspect, the first suggestion information for the action of the user is adjusted to be appropriate to the state of the user similarly as in the first aspect. The first suggestion information may be included in the content of the second suggestion information or may be added to the second suggestion information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), systems on chips (SOCs), graphics processing units (GPUs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An action suggestion apparatus comprising circuitry configured to
receive condition information of a user from a communication terminal used by the user,
generate first suggestion information for an action of the user based on the received condition information,
transmit the generated first suggestion information to the communication terminal,
receive, from the communication terminal, result information representing a result of the action of the user based on the first suggestion information, and
generate second suggestion information for the action of the user based on the received result information.

2. The action suggestion apparatus of claim 1, wherein the circuitry causes a display to display the second suggestion information generated for the user.

3. The action suggestion apparatus of claim 1, wherein the condition information, based on which the circuitry generates the first suggestion information, includes at least one of
attribute information representing an attribute of the user,
physical and mental information related to a body and mind of the user,
environmental information related to an environment surrounding the user, or
schedule information representing a schedule of the user.

4. The action suggestion apparatus of claim 1, wherein the circuitry updates a particular machine learning model in accordance with the result information to generate the second suggestion information.

5. The action suggestion apparatus of claim 1, wherein the circuitry weights the first suggestion information in accordance with the result information corresponding to the first suggestion information generated for the user, and generates the second suggestion information for the user in accordance with the weighting.

6. The action suggestion apparatus of claim 5, wherein when the result information represents a positive result, the circuitry weights the first suggestion information to increase a priority of the first suggestion information being generated again and generates the second suggestion information in accordance with the weighting, and
where when the result information represents a negative result, the circuitry weights the first suggestion information to lower the priority of the first suggestion information being generated again and generates the second suggestion information in accordance with the weighting.

7. The action suggestion apparatus of claim 6, wherein when the first suggestion information is weighted to increase the priority of the first suggestion information being generated again, the circuitry sets a limit in generating the second suggestion information in accordance with the weighting so as to generate the second suggestion information in accordance with physical and mental information of the user.

8. The action suggestion apparatus of claim 3, wherein the circuitry weights the first suggestion information based on information including other result information of another user whose attribute information is similar to the attribute information of the user.

9. The action suggestion apparatus of claim 1, wherein the circuitry transmits the first suggestion information to the communication terminal with particular timing according to the condition information and the result information of the user.

10. The action suggestion apparatus of claim 1, wherein the circuitry generates same suggestion information as the first suggestion information and the second suggestion information.

11. An action suggestion system comprising:
the action suggestion apparatus of claim 1; and
the communication terminal used by the user, comprising another circuitry configured to cause a display to display the second suggestion information generated for the user.

12. An action suggestion method comprising:
receiving condition information of a user from a communication terminal used by the user;
generating first suggestion information for an action of the user based on the received condition information;
transmitting the generated first suggestion information to the communication terminal;
receiving, from the communication terminal, result information representing a result of the action of the user based on the first suggestion information; and
generating second suggestion information for the action of the user based on the received result information.

13. A non-transitory recording medium storing a plurality of instructions which, when executed by one or more processors, causes the one or more processors to perform an action suggestion method comprising:
receiving condition information of a user from a communication terminal used by the user;
generating first suggestion information for an action of the user based on the received condition information;
transmitting the generated first suggestion information to the communication terminal;
receiving, from the communication terminal, result information representing a result of the action of the user based on the first suggestion information; and
generating second suggestion information for the action of the user based on the received result information.
